(19) United States
(12) Patent Application Publication
(10) Pub. No.: US 2010/0138791 A1
(43) Pub. Date: Jun. 3, 2010

(54) Content Exchange System

(75) Inventor: Richard L. Anglin, JR., Del Mar, CA (US)

Correspondence Address: The Caldwell Firm, LLC, PO Box 59655, Dept. SVIPGP, Dallas, TX, 75229, US

(73) Assignee: STRAGENT, LLC, Longview, TX (US)

(21) Appl. No.: 12/699,857

(22) Filed: Feb. 3, 2010

Related U.S. Application Data
(62) Division of application No. 11/318,427, filed on Dec. 23, 2005.
Application No. 11/318,427 is a continuation-in-part of application No. 11/176,006, filed on Jul. 5, 2005.

(51) Int. Cl. G06F 3/048

(52) U.S. Cl. 715/835

(57) ABSTRACT

The present invention comprises methods and apparatus for providing more content choices to a user (14) independent of their geography. In one embodiment of the invention, a user (14) utilizes a content terminal (18) to enjoy and audio and/or video content based on a customized set of content preferences (34) . The present invention retrieves digital files utilizing a wired or wireless Internet connection over a network (20), irrespective of the location of the user (14). In one embodiment of the invention, the content terminal (18) is a personal computer, cell phone, portable television or some other appropriate content replication appliance. Users (14) may search for and obtain content selections (36) by accessing a website which displays a library of content in the form of an easy-to-use graphical interface.

### CROSS-REFERENCE TO A RELATED PENDING U.S. PATENT APPLICATION & CLAIM FOR PRIORITY

This Patent Application is a Continuation-in-Part Application, and is related to Pending U.S. patent application Ser. No. 11/176,006 entitled Content Selection & Retrieval System, which was filed on 5 Jul. 2005. The Applicant hereby claims the benefit of priority under 35 USC Sections 119 & 120 for any subject matter that is shared by the Present Application and U.S. Ser. No. 11/176,006.

### FEDERALLY SPONSORED RESEARCH OR DEVELOPMENT

None.

### FIELD OF THE INVENTION

The present invention pertains to methods and apparatus for providing a central exchange for content files which may be accessed by users via wired or wireless connections. More particularly, one preferred embodiment of the invention allows a user to search for particular content such as musical works, movies, television or radio shows, e-books, newspapers, magazines, scholarly journals or any other forms of digitized content for delivery to the user on demand at virtually any location on the globe. The user is able to select the time for the download of the content, and is also able to select a device to which the content is downloaded.

### BACKGROUND OF THE INVENTION

The vast majority of real-time broadcasts of audio-visual content, such as cable television, over-the-air or satellite television and radio, are constrained by geography. A particular over-the-air radio or television broadcast is only available to a conventional radio or television receiver if the user is within the broadcast footprint of the transmitting station. Cable subscribers must be linked to a wired or wireless cable connection, and may only receive content conveyed by the cable operator or network. Even direct-to-home satellite radio and television broadcasts are limited by the continental footprints of the satellite signal. Some Internet websites like mp3.com and Google® Video offer some form of content downloads, but to not allow the user to specify either a preselected time for the download or a preselected device to which the content is to be conveyed.

As a result, a person in one location may be unable to enjoy content that is broadcast in another place that is remote from his own present location.

Furthermore, no previous system provides a convenient intermediary that offers an easy-to-easy graphical interface which enables a user to select specific content selections from a large library for immediate or scheduled use, listening, viewing and have that content delivered to a desired location and a desired device.

The development of a system would enable users to enjoy audio and/or video and/or image, graphical or text content in any location and at any time would constitute a major technological advance, and would satisfy long felt needs and aspirations in the telecommunications and electronics industries.

### SUMMARY OF THE INVENTION

The present invention comprises methods and apparatus for providing more content choices to consumers independent of their geography and schedule. In one embodiment of the invention, a consumer uses a content terminal to enjoy and audio, image, text and/or video content based on a customized set of content preferences.

The present invention retrieves digital files utilizing a wired or wireless Internet connection, irrespective of the location of the user. In one embodiment of the invention, the content terminal is a personal computer, cell phone, portable television or some other appropriate content replication appliance.

One embodiment of the invention also provides an easy-to-use graphical interface that allows users to search for and/or obtain specific selections for immediate use or for use at a time scheduled in the future. The present invention allows the user to not only select the time for the download, but also allows the user to select a device to which the content will be conveyed.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 shows a generalized map of the United States. Eight different transmitters located in eight different geographic regions broadcast eight generally different programs of content.

FIG. 2 shows a motorist who is unable to enjoy content broadcast by a distant transmitter.

FIG. 3 shows a traveler who is enjoying content that originates from a radio station near his home in accordance with the present invention.

FIG. 4 is a schematic block diagram which illustrates the routing of a preferred selection of content over the Internet to a user in a distant location.

FIG. 5 is another schematic block diagram which reveals the generalized circuitry of a user's content terminal.

FIG. 6 presents a view of content preferences displayed on the screen of a user's content terminal.

FIG. 7 shows a Subscriber Identity Module (SIM), also known as a “smart card.”

FIG. 8 shows an example of the digital information that may comprise the digital information embodied in the Subscriber Identity Module.

FIG. 9 shows a cable television or digital broadcast satellite set top box content terminal with a plurality of slots for Subscriber Identify Modules.

FIG. 10 shows a set top box distribution of content using wires.

FIG. 11 shows a set top box distribution of content using wireless communications devices.

FIG. 12 shows multiple facilities in different locations with access to the same network.

FIG. 13 shows a Subscriber Identity Module (SIM) with an embedded biometric identification device.

FIG. 14 shows multiple facilities in different locations with access to the same digital broadcast satellite system.

FIG. 15 shows getting a user's desired content from his or her home system to a foreign system in which he or she is located.

FIG. 16 shows the correlation table that allows a foreign network to deliver desired content to a user from another network.

FIG. 17 shows an intermediary-based business model for the distribution of content.

FIG. 18 shows the network as a fixed wireless communications system.

FIG. 19 shows the network as a fixed wireless communications system with wireless distribution.

FIG. 20 shows a network for delivering content wirelessly directly to users whether fixed or mobile.

FIG. 21 shows content terminals embedded into fixed and mobile conveyances.

FIG. 22 shows a plurality of content terminals with a plurality of built in Subscriber Identity Module slots.

FIG. 23 shows a weary traveler inserting his Subscriber Identity Module into a television in a hotel room.

FIG. 24 shows a plurality of means a user uses to access the Internet.

FIG. 25 shows the home page of a Web site.

FIG. 26 shows a pull down menu for the selected content on the Web site home page.

FIG. 27 shows a pop-up screen for content selection.

FIG. 28 shows the content of the pop-up screen for selected content.

FIG. 29 shows the payment screen of a Web site.

FIG. 30 shows the begin viewing screen of a Web site.

FIG. 31 shows the storage options screen of a Web site.

FIG. 32 shows a user access to his or her account.

FIG. 33 shows a preferred embodiment of the invention.

FIG. 34 shows a first preferred embodiment of a means of doing business to practice the invention.

FIG. 35 shows a second preferred embodiment of a means of doing business to practice the invention.

FIG. 36 shows a third preferred embodiment of a means of doing business to practice the invention.

FIG. 37 shows a fourth preferred embodiment of a means of doing business to practice the invention.

FIG. 38 shows the contents of the pop-up screen for selected content with market trading prices.

FIG. 39 shows a “bid accepted” pop-up box.

FIG. 40 shows a “bid not accepted” pop-up box.

FIG. 41 shows the begin viewing screen of a Web site with market trading prices.

FIG. 42 shows a wholesale trading embodiment of the invention.

FIG. 43 shows a pull down menu for the selected content on the Web site home page with market trading prices.

FIG. 44 shows a conceptualization of the invention.

FIG. 45 shows a preferred embodiment of the invention.

FIG. 46 shows a plurality of screens for the user to register information on a Web site.

FIG. 47 shows how a user associates available content selections with an available delivery network.

FIG. 48 shows a pop-up box with schedule options.

FIG. 49 shows the contents of the pop-up box of schedule options.

FIG. 50 shows a content schedule.

FIG. 51 shows an options pop-up box.

FIG. 52 shows a pop-up box for registering available recording devices.

FIG. 53 shows a pop-up box for giving instructions during a broadcast of media.

FIG. 54 shows a specific embodiment of the invention with a plurality of media content that would be important in formulating policy to respond to a hurricane on the United States Gulf Coast.

FIG. 55 shows a specific embodiment of the invention with a plurality of media content that would be important to support logistics in response to a hurricane on the United States Gulf Coast.

FIG. 56 shows a specific embodiment of the invention with a plurality of media content that would be of interest to a trucker driving along Interstate 80 through the State of Wyoming.

FIG. 57 shows a specific embodiment of the invention with a plurality of media content that would be of interest to an international traveler.

FIG. 58 shows a specific embodiment of the invention in which a Customs and Border Control Inspector of the U.S. Department of Homeland Security assigned to inspect containers on a vessel arriving in a port receives a list of arriving vessels on his media terminal.

FIG. 59 shows a specific embodiment of the invention with a plurality of media content that would be of interest to a Customs and Border Control Inspector of the U.S. Department of Homeland Security assigned to inspect containers on a vessel arriving in a port.

FIG. 60 shows a specific embodiment of the invention with a plurality of media content that would be of interest to a farmer.

FIG. 61 shows a specific embodiment of the invention with a plurality of media content in an oil and gas industry Supervision, Control and Data Acquisition application.

FIG. 62 shows a specific embodiment of the invention with a plurality of media content in a surveillance application in a port.

FIG. 63 shows a specific embodiment of the invention with a plurality of media content in a surveillance application in a residence.

FIG. 64 shows a specific embodiment of the invention with a plurality of media content for military operations planning.

FIGS. 65, 66 and 67 depict an embodiment for the distribution of e-books.

FIGS. 68 and 69 show content selections being delivered to a car on the road.

FIG. 70 depicts entering a geographic location into the Web site to obtain listings of available content selections.

### A DETAILED DESCRIPTION OF PREFERRED & ALTERNATIVE EMBODIMENTS

### I. Overview of the Invention & Definitions

The present invention comprises methods and apparatus for furnishing a menu or library of content to a user via a network connection. In one embodiment, the invention comprises a content terminal that retrieves selected audio, image, text and/or visual content from the Internet based on a user's personal preferences at the time and place the user chooses.

In this Specification and in the Claims that follow, the term “broadcast” refers to a method of signal conveyance that propagates from a transmitter to a number of terminals in remote locations. The term “signal” may be used to encompass many forms of content, including, but not limited to, video, still images, audio, text or any other form of intelligence, data or communication.

The present invention may be implemented using a personal or portable computer, television, cellular phone, or information appliance, or any other means for exhibiting or reproducing data.

### II. A Detailed Description of the Invention

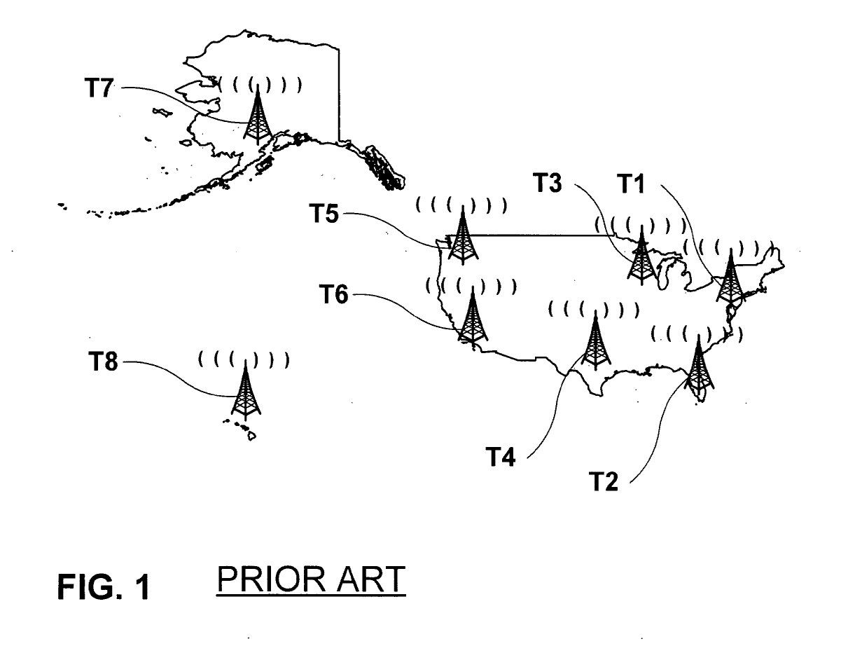

FIG. 1 shows a map of the United States. Eight transmitters T1, T2, T3, T4, T5, T6, T7, T8 broadcast conventional radio or television signals from New York, Miami, Chicago, Dallas, Seattle, Los Angeles, Anchorage and Honolulu respectively. Each of these eight conventional over-the-air signals may generally be received and enjoyed by users in a geographic region near or around each transmitter. For example, persons with conventional amplitude modulation (AM) radios in Los Angeles are generally not able to receive radio broadcasts from AM stations that broadcast signals in New York.

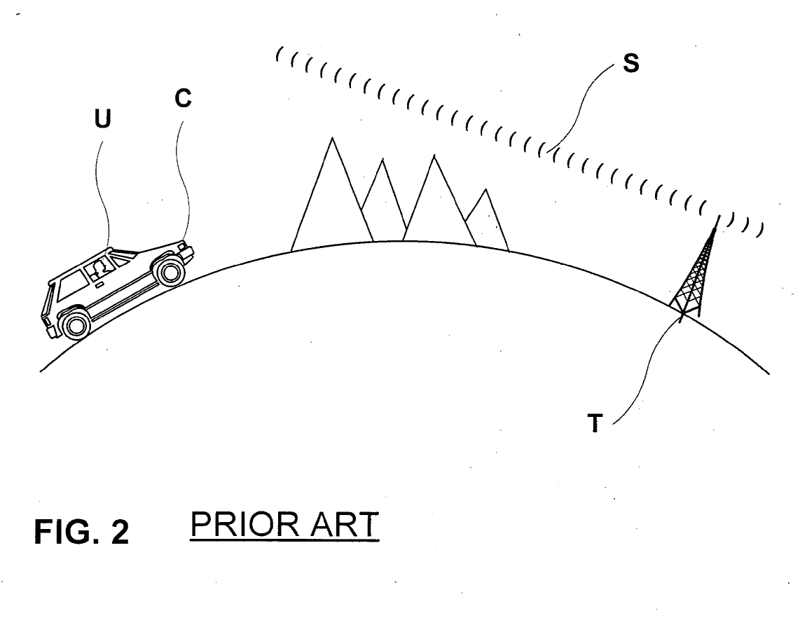

FIG. 2 depicts the same problem in a different setting. A motorist U traveling in his car C is too far away from a conventional over-the-air transmitter T to receive the distant radio signal S using his conventional car radio.

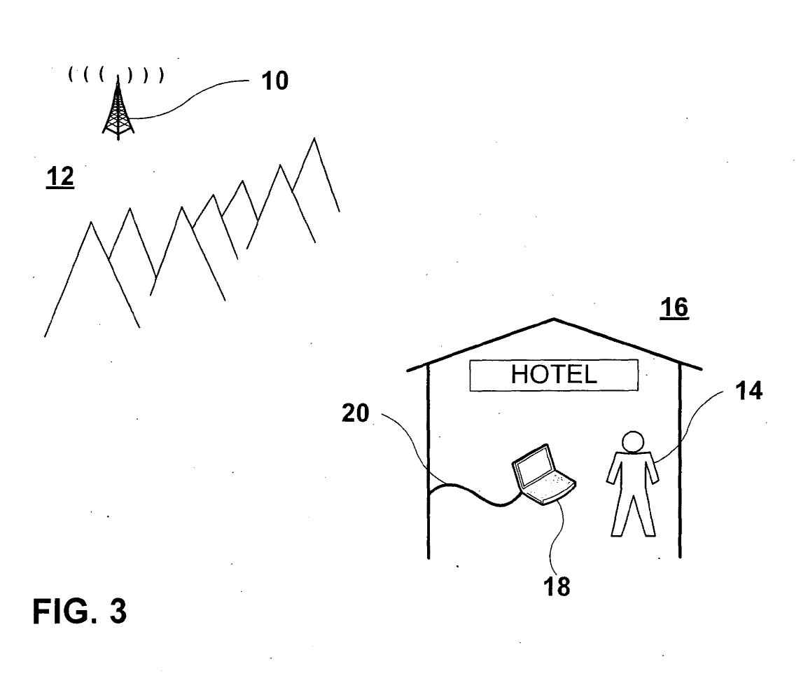

FIG. 3 offers a simplified illustration of one embodiment of the present invention. A conventional transmitter 10 located in a particular city 12 broadcasts a conventional over-the-air radio broadcast. When a person 14 who lives in that city 12 travels away from home to a distant location 16, he is unable to enjoy the radio program broadcast by his hometown transmitter 10. In accordance with the present invention, the traveler 14 is able to enjoy his favorite hometown radio program using a content terminal 18 and a connection to a network 20.

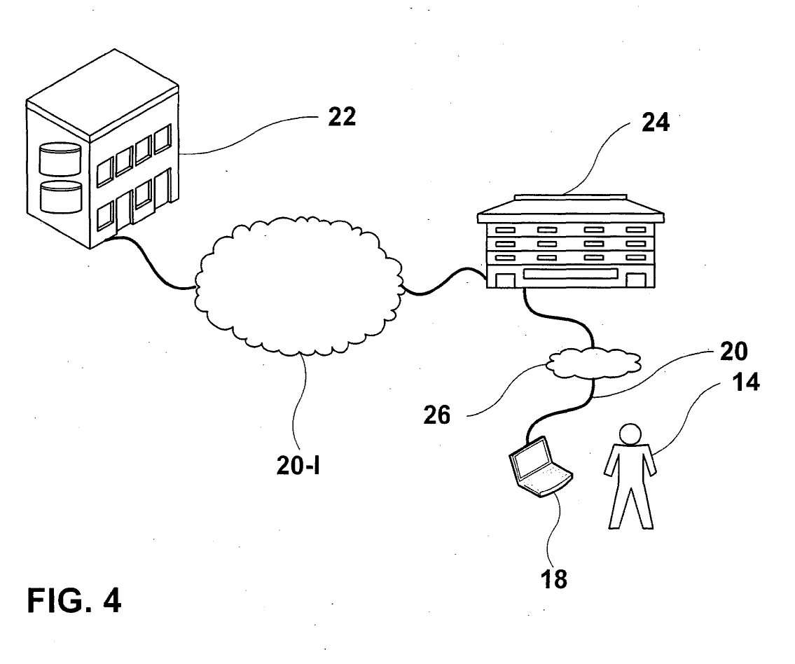

FIG. 4 provides a more schematic view of the generalized embodiment of the invention shown in FIG. 3. A content provider 22 makes the content broadcast by his station available to users 14 who are connected to a network 20. In a preferred embodiment of the invention, the network 20 is the Internet, which has been assigned the reference character 20-I. In an embodiment of the invention, users 14 are linked to the Internet 20-I via an Internet Service Provider 24, which allows them to use a content terminal 18 to retrieve audio, image, text and/or visual content or other forms of data or information. The content may be stored in a network cache 26. This network cache 26 may be located at the Internet Service Provider 24, in the content terminal 18, or at some other location that may be connected to the Internet 20-I or some other network 20.

In this Specification, and in the Claims that follow, elements of the invention are identified by reference characters which denote the relationship among broad, generalized recitations of elements, and the various, more specific implementations of those broad recitations. For example, the term “network” is associated with reference character 20, while one specific embodiment, “Internet,” which falls within the scope of the broader term “network” is associated with reference character 20-I. In general, a broad recitation is identified by a numerical reference character, such as “20”. More specific embodiments that are encompassed by the broad recitation are identified a reference character that combines a number with a capital letter, such as “20-I.”

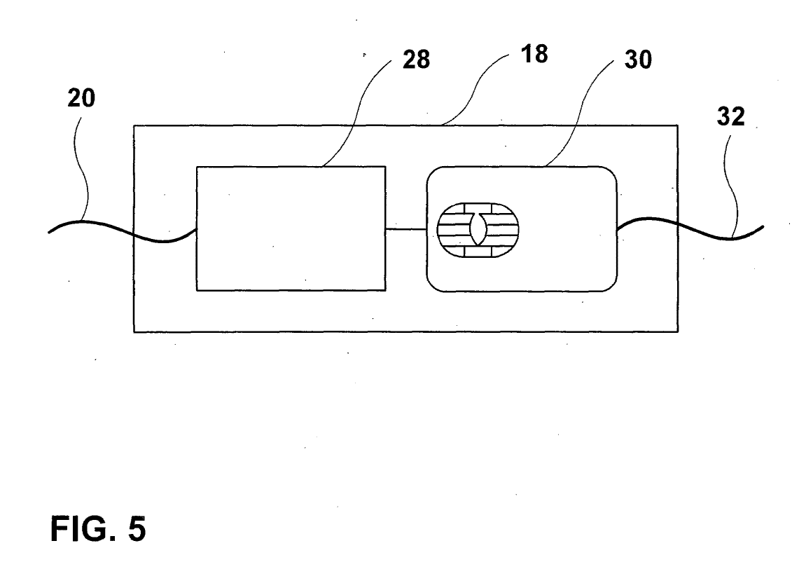

FIG. 5 supplies a more detailed schematic portrayal of this embodiment of the invention. The content terminal 18 comprises a content retriever 28, a Subscriber Identity Module (SIM) 30, and a user interface 32. The content retriever 28 is able to retrieve selected content using the connection to the network 20 based on the content preferences 34 stored in the memory of the SIM 30 and deliver content to a user interface 32. In the case of audio, the user interface 32 comprises headphones or speakers and a visual display; in the case of text, image or video content it also comprises a visual display. In general, a content preference 34 encompasses information or data that identifies or describes content which a user 14 wishes to download or access.

Today the most common manifestation of a SIM is a small electronic card that may be inserted into a mobile cellular phone. The SIM associates a fixed unique identification to that device as well as unique subscriber identification. The SIM enables a cellular phone company to track phone calls from that phone to provide billing statements to a customer. The SIM may also be employed to gain access to different cellular networks, or to encrypt phone calls. SIMs are increasingly used in a variety of applications. For example, soldiers' medical records are stored in SIMs that are embedded into their military identification cards. Similarly, many companies are using SIM-based identification cards to control access to facilities, especially facilities comprising sensitive information or activities.

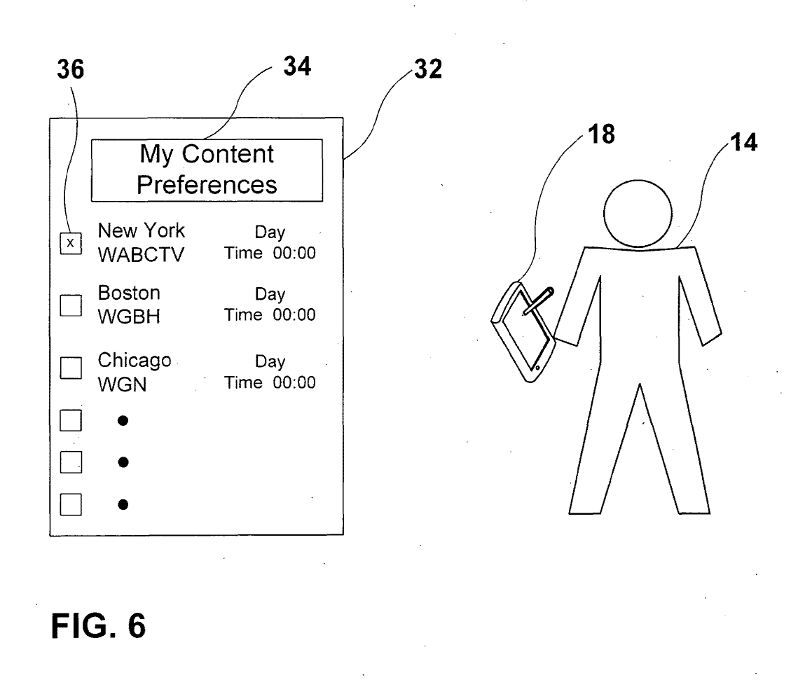

FIG. 6 reveals a user 14 programming his or her content terminal 18. By selecting from a list of content or programs presented on the user interface 32 of the content terminal 18, the user's content preferences 34, the user 14 instructs the SIM 30 to instruct the content retriever 28 to automatically retrieve selected content 36 from the network 20 and then store it in his or her content terminal 18 or the network cache 26 so that the user 14 may enjoy the selected content 36 at a future time of her choosing.

### III. Details of Specific Implementations of the Invention

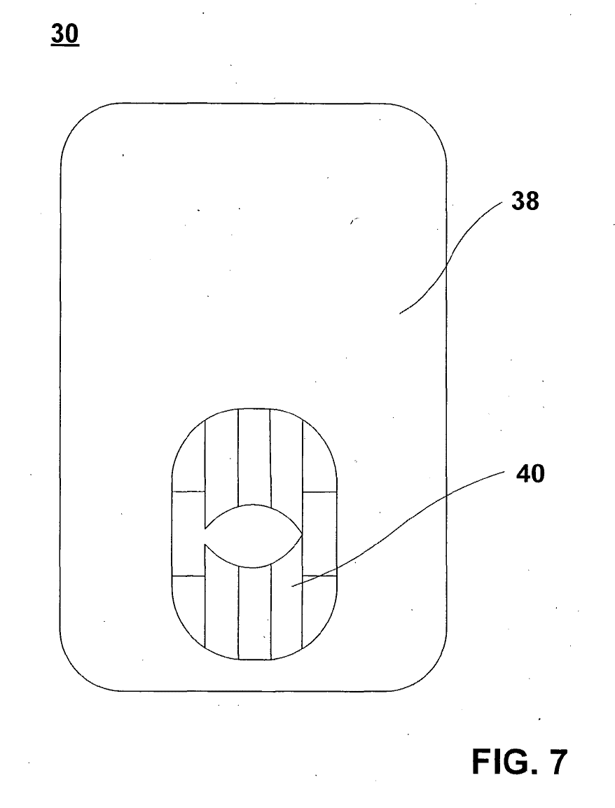

FIG. 7 offers a schematic depiction of the SIM 30, which may comprise a small card or substrate 38 that includes an embedded electronic memory and processor 40. In some instances, the SIM is also referred to as a “smart card.” In one embodiment of the invention, the SIM 30 is used to store content preferences 34 specified by the user 14. The SIM memory 40 may also retain information that is employed for user authentication, authorization and validation. Any device and/or software and/or user input may provide an equivalent means of performing the function of the SIM. The functionality of the SIM 30 may be embodied in a plurality of form factors such as commercially available Universal Serial Bus (USB) Jump Drives, various forms of flash memory cards, such Secure Digital (SD), CompactFlash (CF), SmartMedia (SM), Sony Memory Stick (MS), MultiMediaCard (MMC) and xD-Picture Card (xD), or a login with a password. For example, the user may enter a password or some other form of identification, instructions or preferences instead of relying upon information stored in the SIM 30.

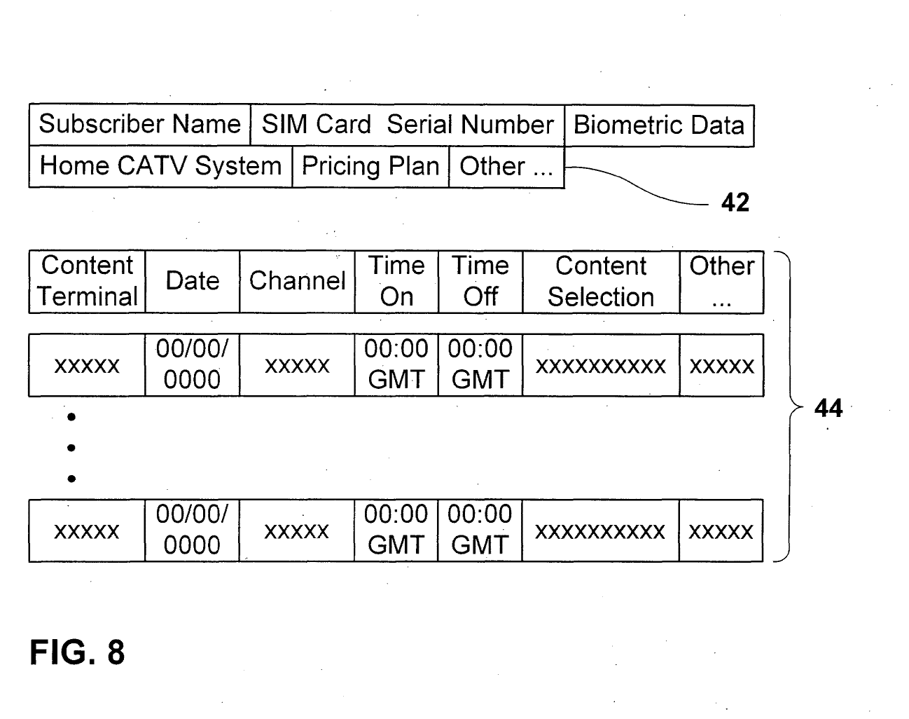

FIG. 8 presents a depiction of classes of information that may be stored in the SIM 30. The various kinds of information that may be stored in the SIM 30 may include, but are not limited to, basic operating information 42, such as a user or subscriber name, a SIM card 30 serial number, biometric data, identifying information concerning the user's home network 20, an example of which is a Community Access Television (CATV) system, better known as his or her “cable television system,” and pricing plan. The SIM 30 may also be utilized to store a content schedule 44 that comprises a specification of a content terminal 18 and information pertaining to a content selection 36, including, but not limited to, the title, the date and time of its emanation from a content provider 22, and the date and time for delivery to a content terminal 18.

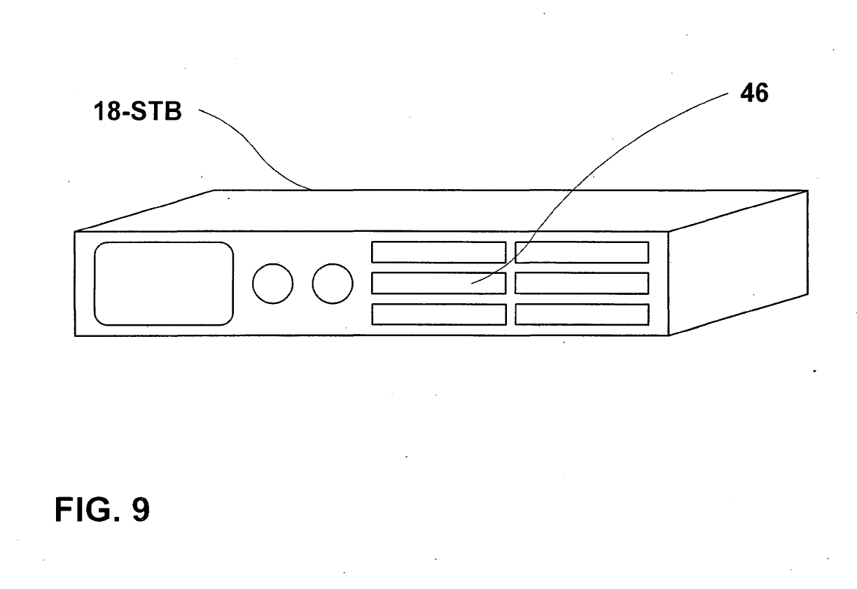

In an alternative embodiment of the invention, a set top box 18-STB that is capable of receiving signals from a network 20, such as a cable television system or Direct Broadcast Satellite (DBS) system; is configured with a plurality of slots 46 to receive a plurality of SIMs 30 as shown in FIG. 9. A set top box 18-STB with multiple slots 46 allows more than one user 14 to record and store their content selections 36.

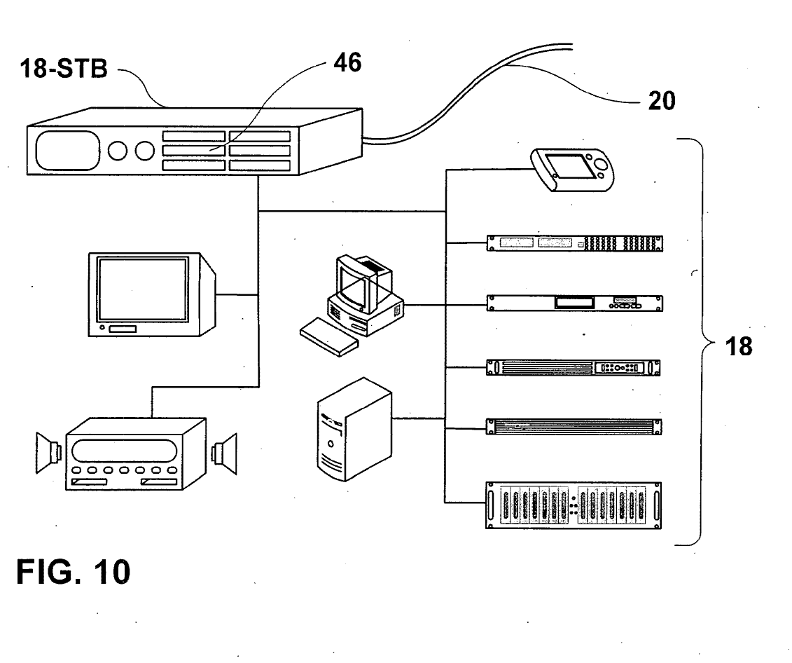

The set top box 18-STB may utilize a network 20 to route content selections 36 to a wide variety of content terminals 18, including, but not limited to, a radio, a television, a personal computer (PC), a Personal Digital Assistant (PDA), a programming content server, a video cassette recorder or player (VCR), a digital video disk player or recorder (DVD), a compact disk player or recorder (CD), a personal digital recorder such as a TiVo®, WebTV®, a CD/DVD juke box and/or a game device, such as the Sony PlayStation® or the Sony PSP®. FIG. 10 illustrates some of these content terminals 18, which may be used to “time shift” a user's content selection 36 because the user 14 may choose the time to use or to enjoy the content selection 36 stored in his or her content terminal 18 or the network cache 26.

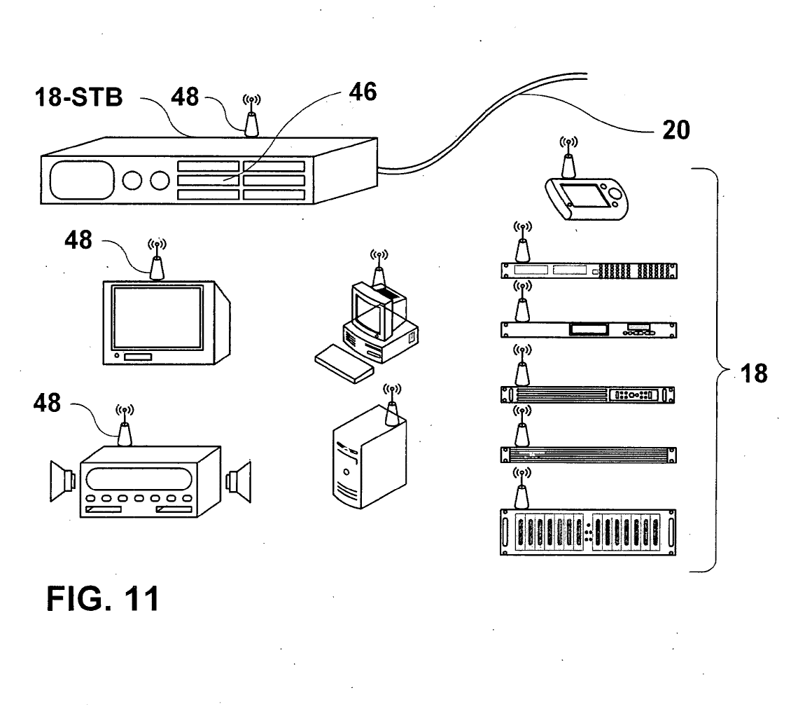

FIG. 11 shows a set top box 18-STB distributing content wirelessly. The set top box 18-STB and each of the content terminals 18 includes a wireless communications device 48, which may utilize a wide variety of wireless formats, including, but not limited to, WiFi, WiMax® or Bluetooth®. Wireless communications devices 48 also enable delivery of content selections 36 to cellular and personal communications service (PCS) telephones 18.

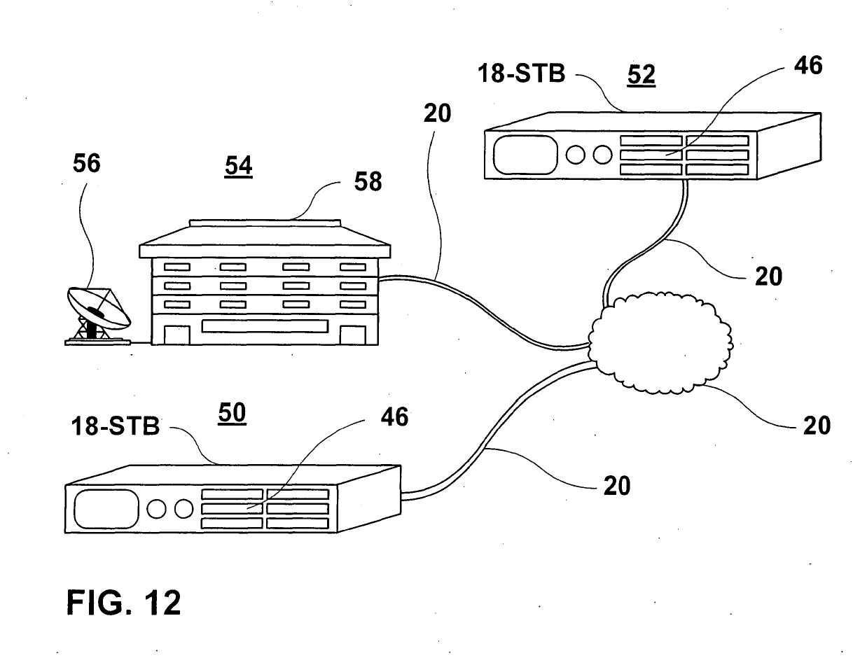

If a user 14 has multiple facilities within the same network 20, he or she may obtain access to his or her content selections 36 from virtually any location, as long as he or she transports a SIM 30 from place to place, as shown in FIG. 12. The user 14 may remove his or her SIM 30 from the set top box 18-STB in a first location 50 and transport it to a second location 52. Because both set top boxes 18-STB are connected to the same network 20, the same content selections 36 may be accessed from the content provider 22 via the network head end 54. The network head end 54 comprises one or more satellite Earth stations 56 for receiving content selections 36 from distant locations as well as other facilities 58 for collecting, storing and/or distributing such content selections 36, including the network cache 26.

In one embodiment of the invention, set top box 18-STB is assigned a unique equipment identification number, which is registered with the network 20. Additionally, each SIM 30 is also associated with a unique identification number. All set top boxes 18-STB and SIMs 30 are registered with the network 20. The inherent transportability of the SIM 30 makes additional means for customer authentication, authorization and validation highly desirable.

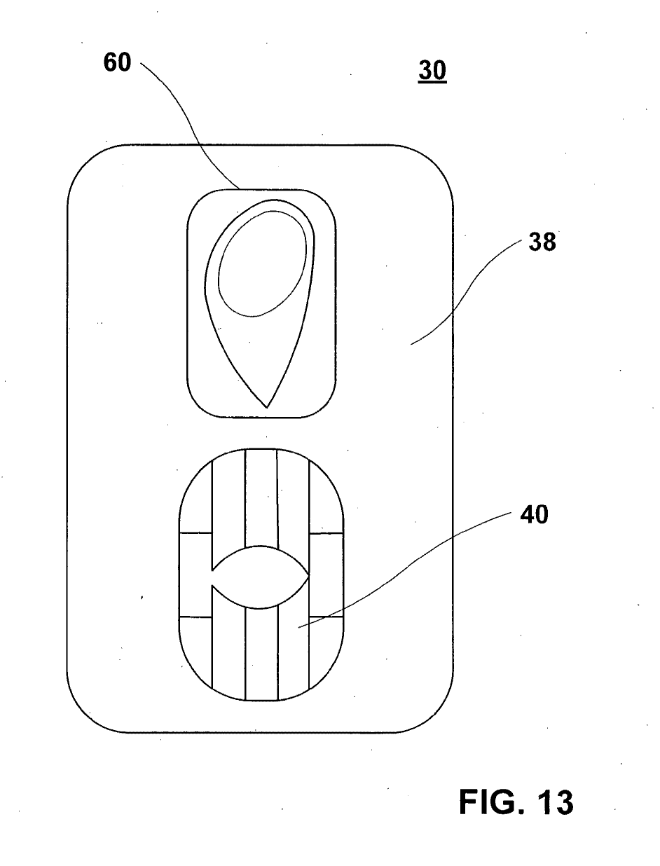

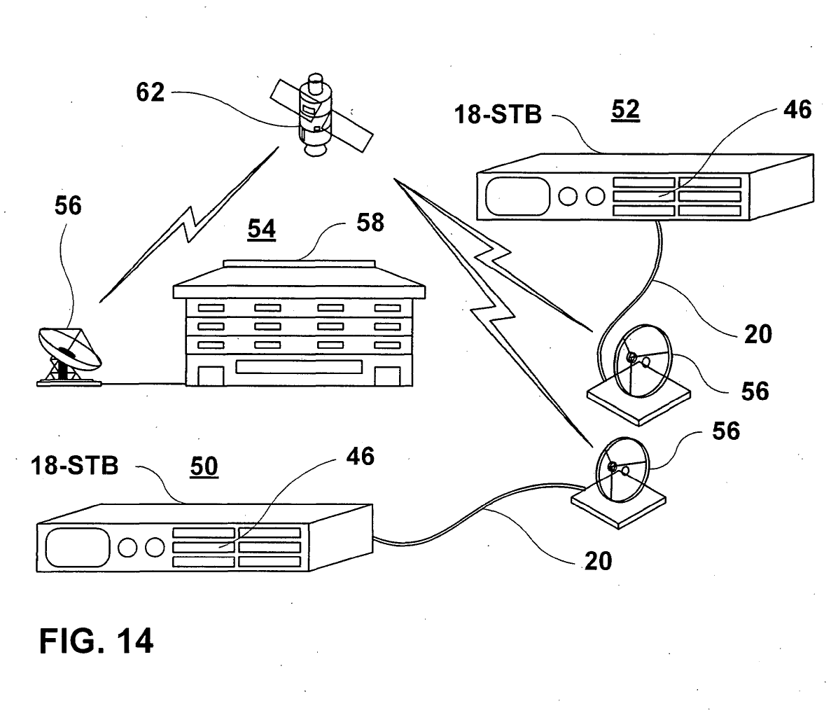

One alternative implementation that achieves this additional security uses a biometric identification device 60 embedded in the SIM 30, as shown in FIG. 13. The biometric identification is registered with the network 20. When the SIM 30 is removed from the first location 50, access to programming is terminated. When the SIM 30 is inserted into the set top box 18-STB in the second location 52, the user 14 is required to access the biometric device 60 to have his or her content selections 36 delivered. The biometric information is sent to the network head end 54 and compared with the registered biometric information. When access is authorized, content selections 36 are sent from an Earth station 56 at the network head end 54 to a satellite 62, then back down to another Earth station 56 and then on to a content terminal 18 over a network 20, as shown in FIG. 14.

The term “biometric authentication” refers to the automatic identification, or identity verification, of living individuals using physiological and behavioral characteristics. Today common biometric devices 60 are fingerprint readers. The user 14 touches his or her finger to the biometric device 60, which scans his or her fingerprint and matches it to a scan stored in a system's basic operating information 42. Single finger readers are available from Identix®, Inc., for example.

A user 14 may be in a different network 20 from his or her usual location, the primary residence for example, and wish to have access to his or her content selections 36. As an example, the user 14 may be located in a vacation or second home. To implement such foreign system access, an operations support system (OSS), including billing, is employed to authenticate, authorize and verify the user's connection to the network 20. One such OSS is that utilized by cellular and PCS systems. In these systems, a user's access, authentication, authorization and verification information is contained in his or her “home” system's Home Location Register (HLR). When the user tries to get cellular or PCS access in another system, the system being visited sends a request to the home system to verify that the user is authorized to use system assets. Upon verification, the user's information is written in the Visitor Location Register (VLR) in the foreign system. The VLR controls visitor access in the foreign system.

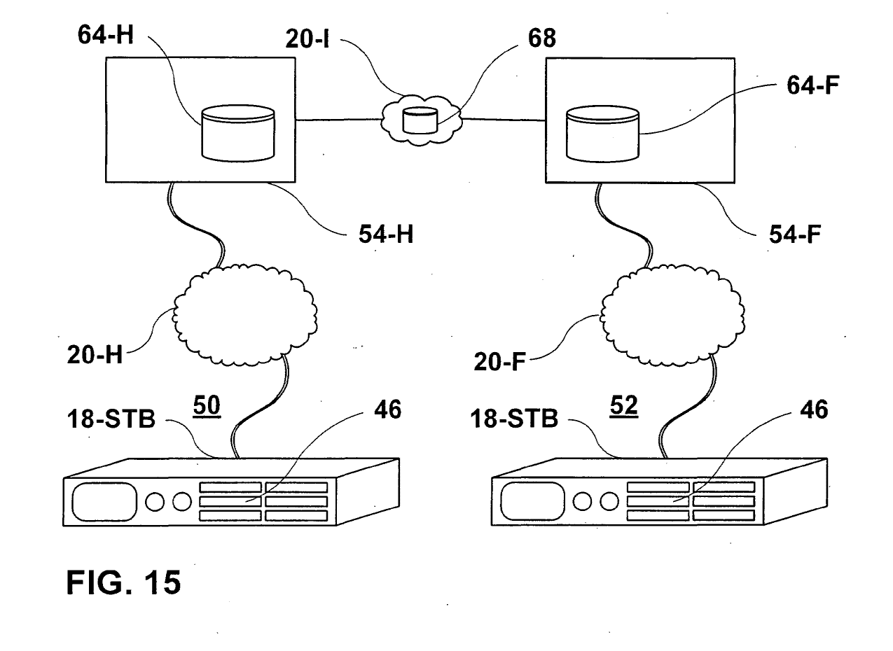

Foreign system access is described in FIG. 15. When the user 14 inserts his or her SIM 30 into the set top box 18-STB in a foreign location 52, a message is sent through the foreign network 20-F to the foreign network head end 54-F. In one embodiment of the invention, the foreign network head end 54-F sends a message via the Internet 20-I, to the home network head end 54-H to verify that the user 14 is authorized to access a content selection 36 via his or her set top box 18-STB. The user's 14 information, which is stored in the home network's database 64-H, is sent from the home network 20-H to the foreign network's database 64-F, and the user 14 is granted access to his or her content selections 36. The home network database 64-H is analogous to the HLR in a cellular telephone system; the foreign network database 64-F is analogous to the VLR in a cellular system.

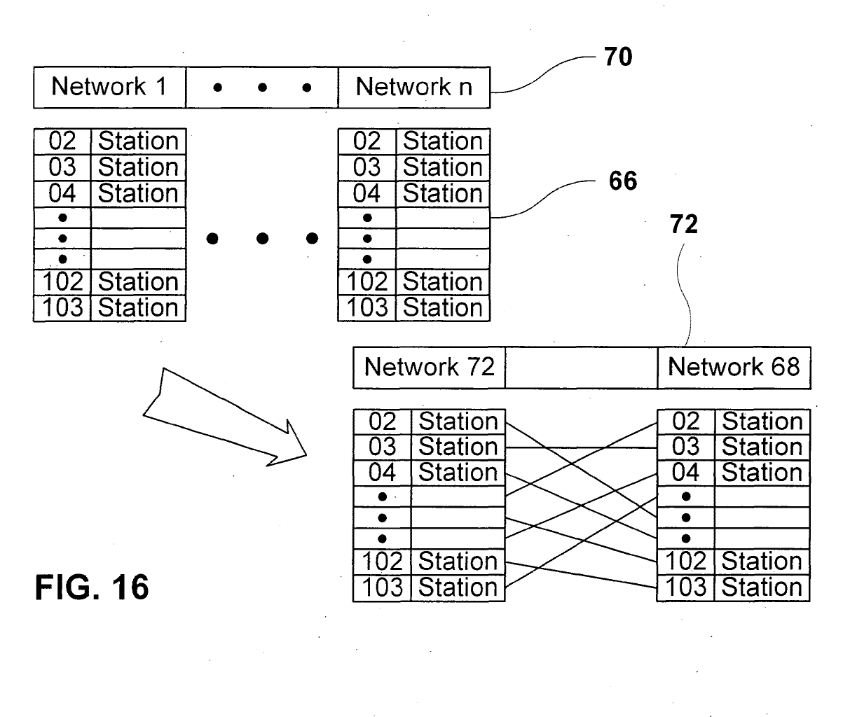

The home network's database 64-H also stores the channel structure 66 of the user's 14 content selections 36, that is, what content is shown on which channel within the network as shown in FIG. 16. For example, on the Time Warner® CATV system in San Diego, Calif., TNT® is shown on channel 27, TBS® on channel 2, WGN® on channel 3, Comedy Central® on channel 68, and so forth. This information is also sent to the foreign network's database 64-F so that the foreign network 20-F knows which content selections 36 to deliver to the user 14.

In another alternative embodiment of the invention, the channel structure 66 is stored in a centralized database 68 and available to all networks 20. Companies like TVGuide® have channel information for the CATV and DBS systems for which they provide an on-line channel guide. The centralized database 68 comprises, but is not limited to, a network identifier 70 and the channel structure 66 for that network 20 as shown in FIG. 16. When the user 14 inserts his or her SIM 30 into a set top box 18-STB in a foreign location 52, a request is sent to the centralized database 68. The centralized database 68 builds a table of cross references 72 of content selections 36 showing how the channel structure 66 of the home network 20-H relates to the channel structure 66 of the foreign network 20-F, and sends it to the foreign network 20-F database 64-F. This cross-reference table 72 enables the foreign network 20-F to deliver the user's 14 content selections 36 to him or her in the foreign location 52.

In an alternative embodiment of the invention, content selections 36 are delivered to users 14 via the Internet 20-I. The cross-reference table 72 aligns the national distribution channels like HBO®, I BS®, TNT®, Discovery®, Animal Planet®, ESPN® and the like. For delivery by the Internet 20-I, the cross reference table 72 is implemented in the foreign network 20-F so it can request that the home network 20-H send the selected content 36 to it for distribution the user 14 in the foreign location 52. In other words, when the user 14 is in New York 52, the New York network 20-F can request the user's 14 home network 20-H in San Diego to send it 20-F the San Diego NBC® affiliate KNSD to deliver to the user 14.

Assume for the remainder of the discussion that any network 20 uses the Internet-standard Internet Protocol (IP).

In an Internet-based embodiment, the process of delivering content selections 36 to a user 14 is highly simplified technically but may be considerably complicated by laws and regulations. In the first instance, the content selections 36 may simply be routed from the home network 20-H via the Internet 20-I to the foreign network 20-F according to the user's 14 preferences stored in his or her SIM 30. Here the content selections 36 are simply routed to the user 14 in a foreign location 52 at the time is it delivered in the home network 20-H. If the user 14 is in New York 52 and wants to see his or her San Diego 50 content selections 36, the three hour time change simply means the user 14 sees a 4 p.m. PST content selection 36 in San Diego 50 at 7 p.m. EST in New York 52. Alternatively, if the user was in Japan 52, the 4 p.m. PST content selection 36 is shown at 8 a.m. JST, which may or may not be convenient for the user 14. Alternatively, if the user was in Switzerland, the 4 μp.m. PST content selection 36 is shown at 1 a.m. CET, most likely inconvenient for the user 14. It would be much more preferable for the user 14 to view his or her selected content 36 at its usual time regardless of where the user 14 is located. To do this requires some type of time shifting content terminal 18 or method. If the time shifting devices 18 in the user's 14 home location 50 are connected to the Internet 20-I, the user's 14 content selections 36 may be captured by one or more of the time shifting content terminals 18 at the time they are normally delivered in the home network 20-H. Then at the user's 14 desired viewing time in the foreign location 52, the selected content 36 may be sent from the time shifting content terminal 18 out through the home network 20-H over the Internet 20-I to the foreign location 52 via the foreign network 20-F.

An alternative embodiment is for the user's 14 content selection 36 to be cached 26 within his or her home network 20-H for delivery whenever the user's 14 SIM 30 appears with a foreign network 20-F. The home network 20-H would know that the user's 14 SIM 30 is not registered with the home network 20-H but would deliver the content selections 36 upon notification that the user's 14 SIM 30 registered in a foreign network 20-H.

A further embodiment is to store the user's 14 content selections 36 within a centralized database 68. His or her content selections 36 would be delivered to the home network 20-H or a foreign network 20-F according the content schedule 44 stored within the centralized database 68.

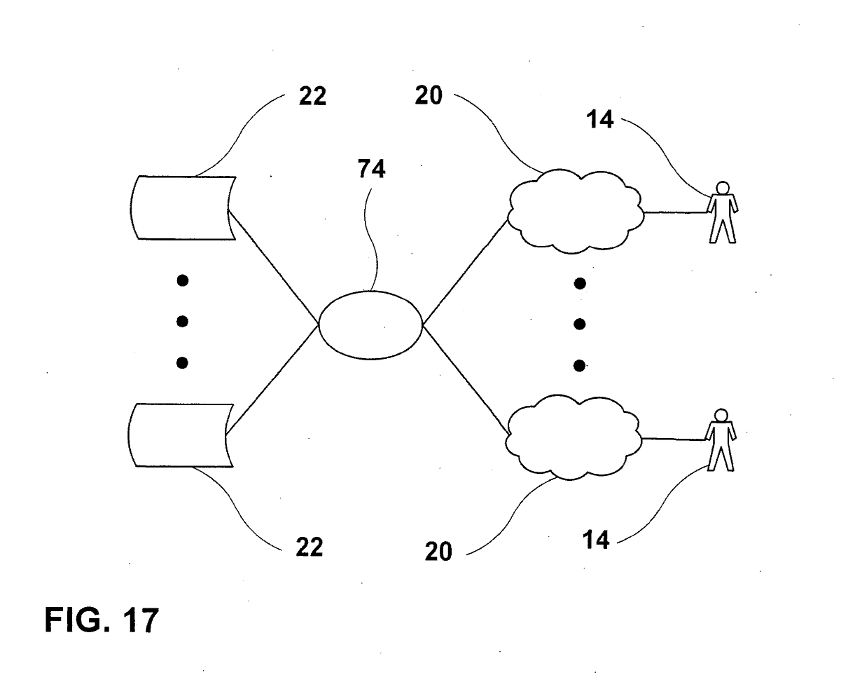

FIG. 17 depicts an Internet-based approach to the delivery of content. Content providers 22, for example, ESPN®, TNT®, TBS, HBO®, KNSD®, XM Satellite Radio®, the California Continuing Education of the Bar and the like, license their programming to an intermediary 74, a “broker,” for delivery via networks 20 to users 14. The networks 20 are traditional CATV or DBS systems, or any other wired or wireless communications networks like ordinary telephone service, cellular, PCS, WiFi, Wi-Max®, Multichannel Multipoint Distribution Service (MMDS), Local Multipoint Distribution Service (LMDS) or Wireless Communications Service (WCS), and the like.

CATV systems are today monopolies within a specific geographic area, for which exclusivity the CATV system pays a franchise fee to the local government. To the extent that the network 20 that the intermediary 74 uses to deliver content selections 36 to a user 14 is a CATV system, then the franchise fee would be embedded into the fees paid by the intermediary 74 to the system operator. Traditional wireless cable systems (not Internet-based) likewise pay local franchise fees. To the extent that the network 20 used to deliver content selections 36 to users 14 is the Internet 20-I, the intermediary 74 would not pay local franchise fees.

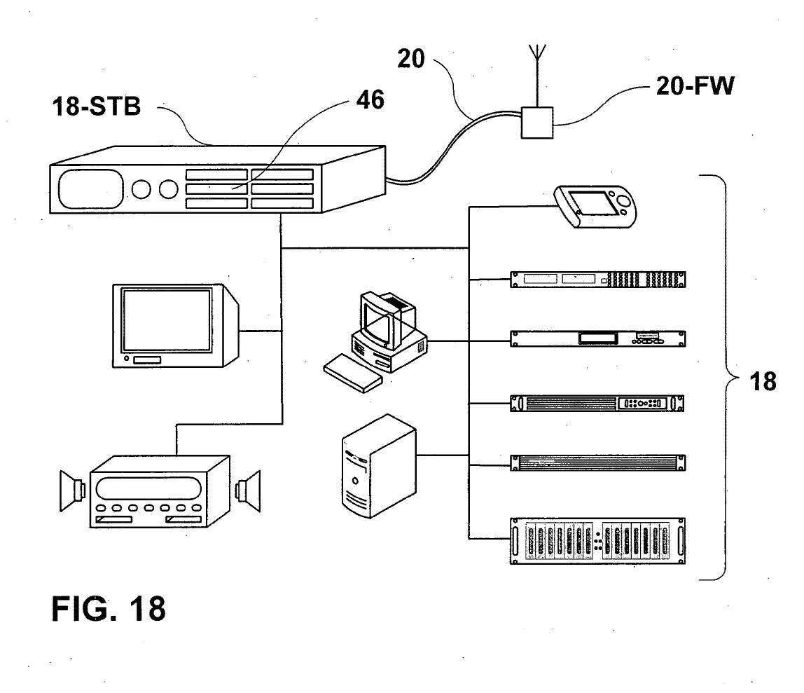

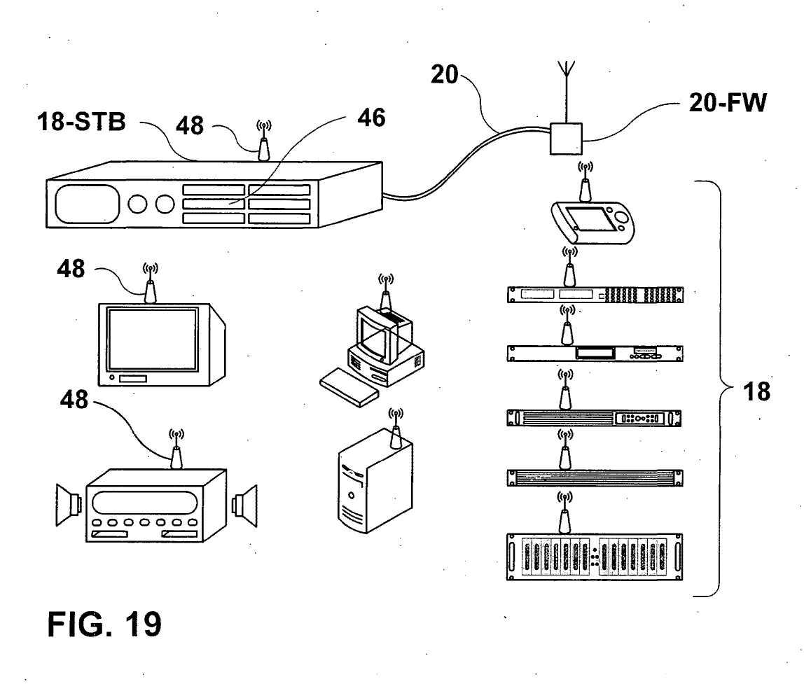

A preferred embodiment of the instant invention comprises wireless delivery of content selections 36 directly to a user 14 via the Internet 20-I. Thus, the embodiment of the invention described in FIG. 10 becomes the embodiment shown in FIG. 18, where the network 20 is a fixed wireless network 20-FW. Similarly, the embodiment shown in FIG. 11 becomes the embodiment shown in FIG. 19.

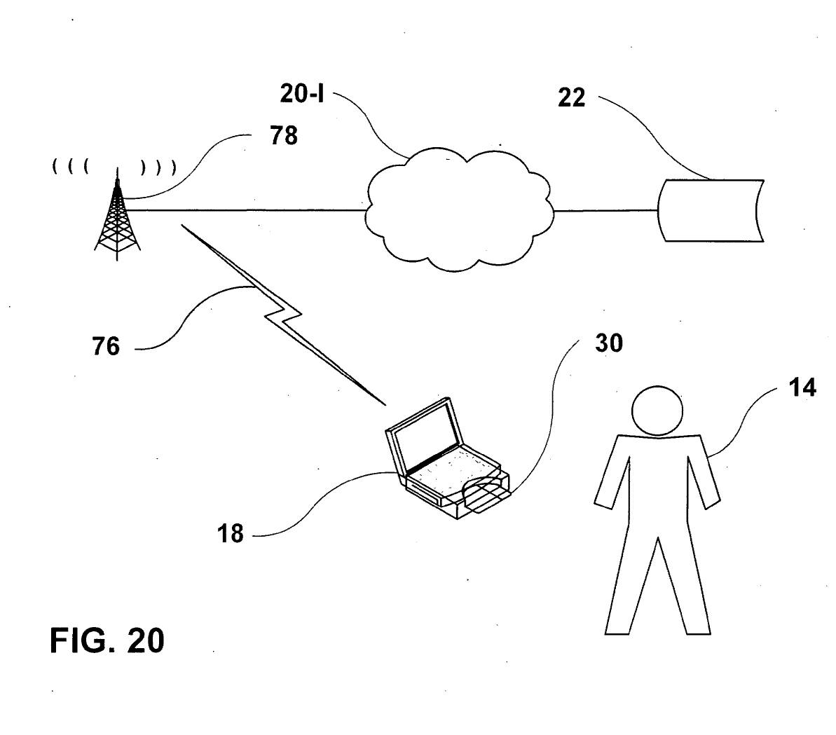

A preferred embodiment of the invention is to deliver the content selections 36 directly to a user 14 wirelessly, whether the user 14 is in a fixed location or mobile. Such an embodiment of the invention is shown in FIG. 20. The user 14 inserts his SIM 30 into a content terminal 18 that sends an IP-based signal 76 to a base station 78 that accesses the global Internet 20-I to retrieve content selections 36 from providers 22 or from the network cache 26. The content selections 36 are delivered via the Internet 20-I to the base station 78 for delivery to the user's 14 content terminal 18 via an IP-based signal 76.

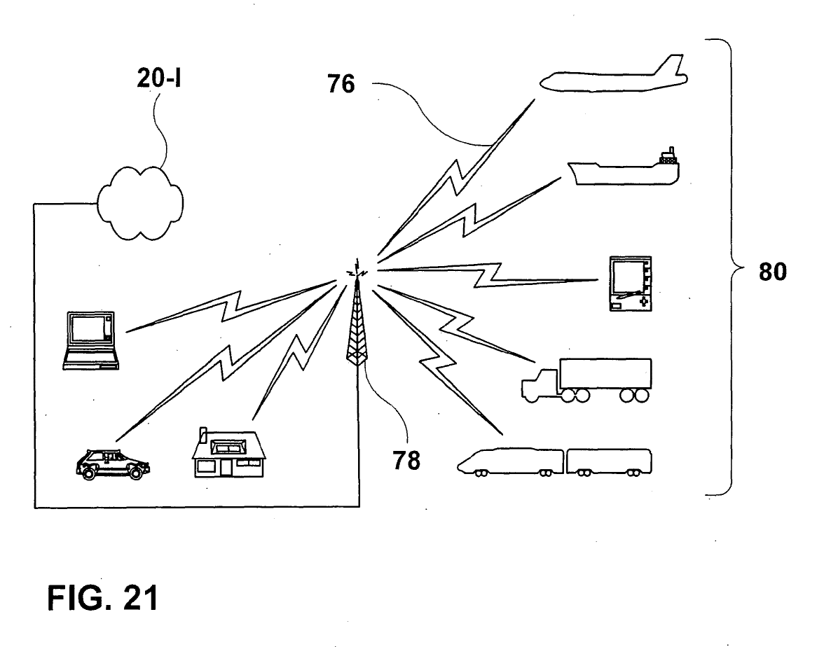

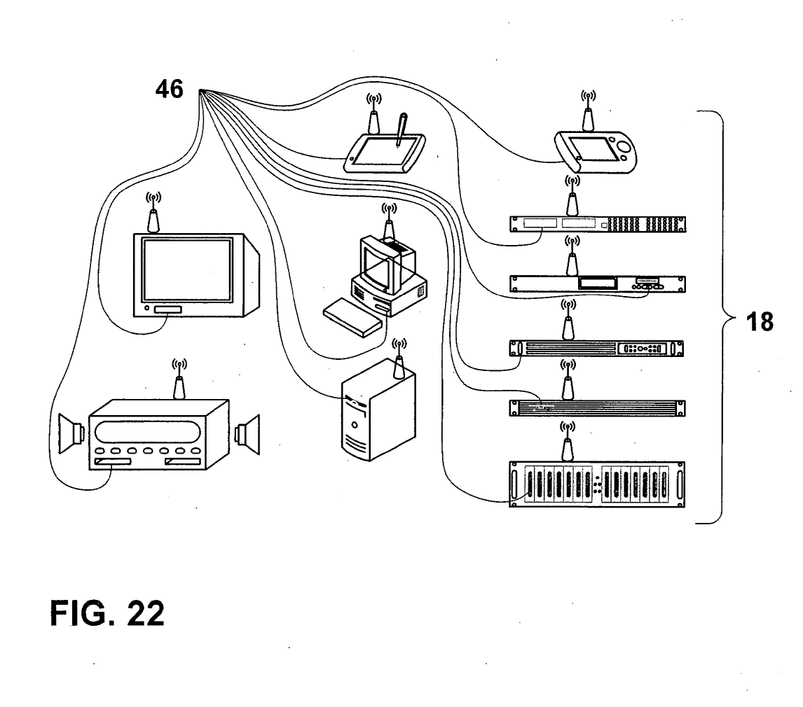

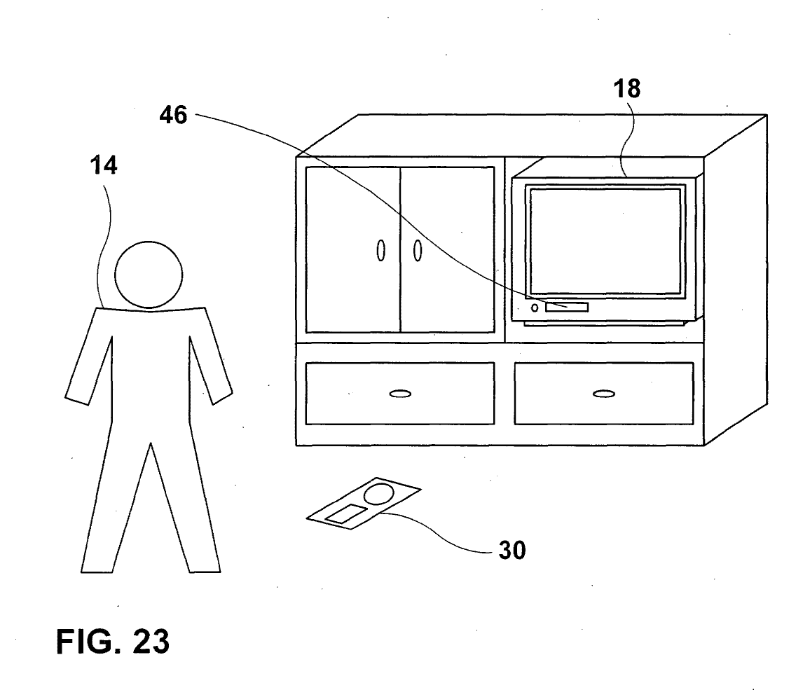

The envisioned content terminal 18, with its concomitant SIM 30, can be a stand alone device or built into mobile conveyances or fixed 80 as shown in FIG. 21, and has been discussed thus far in the context of specific implementations thereof. In a preferred embodiment of the invention, every content terminal 18 includes a SIM slot 46 from the time of its manufacture. Thus, every television, radio, cellular or PCS telephone, CD or DVD player, TiVO, PC, PDA, Apple iPod®, in-dash automobile audio system, tablet computer, cassette player and the like would have at least one SIM slot 46 as shown in FIG. 22. Such an embodiment would enable the user 14 to carry or not carry a content terminal 18 to receive his or her content selections 36. For example, a weary traveler 14 would put his or her SIM 30 into the SIM slot 46 in the hotel room television 18 and receive his or her content selections 36 as shown in FIG. 23.

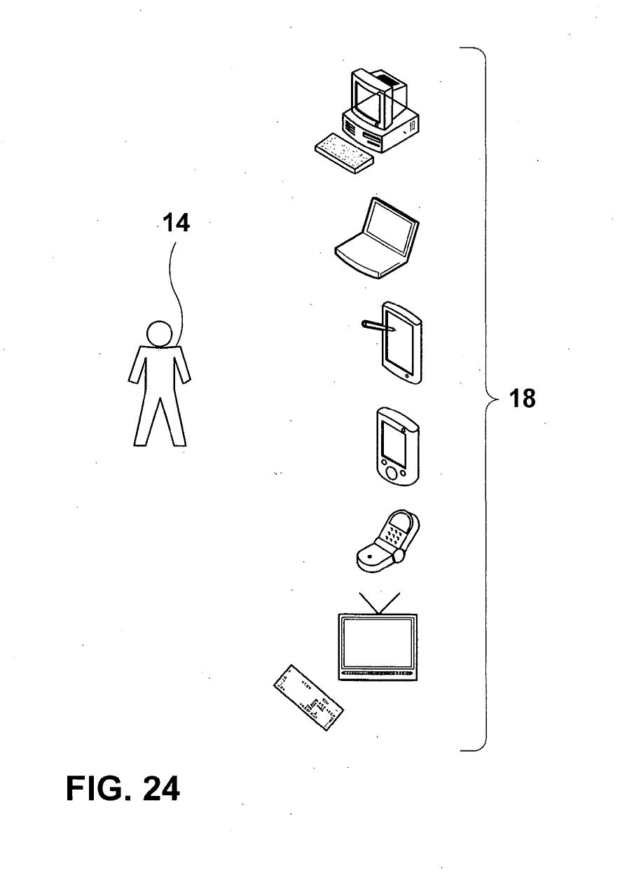

The inherent transportability of the SIM 30 combined with an Internet-based distribution network 20-I enables a user 14 to receive his or her content selections 36 anywhere in the world at a time and place of his or her choosing using a plurality of content terminals 18 as shown in FIG. 24. This system significantly advances the state of the art and contribute innumerable economic benefits to users 14 and providers of such services.

### IV. A Content Exchange

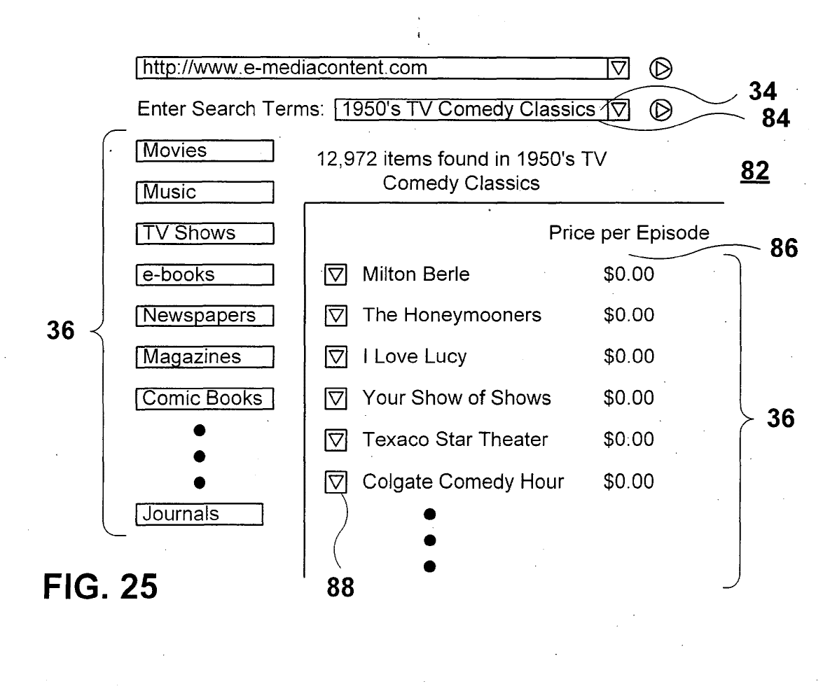

In a preferred embodiment of the invention, the user 14 accesses a Web site home page 82 as shown in FIG. 25 using content terminals 18 as shown in FIG. 24. The Web site home page 82 displays categories of content selections 36 and a search bar 84. When the user 14 enters a description of his or her desired content preferences 34 into the search bar 84, the Web site home page 82 displays content selections 36 matching the description of the content preferences 34 and an associated average price 86. As shown in FIG. 25, if the description of content preferences 34 is “1950's TV Comedy Classics,” the Web site home page 82 displays content selections 36 comprising the shows “Milton Berle,” “The Honeymooners,” “The Lucy Show” and the like.

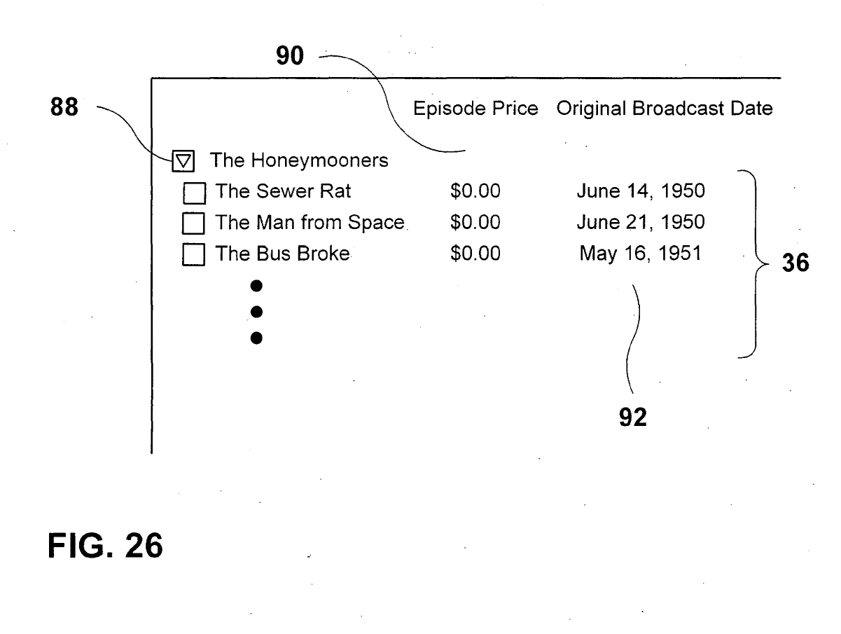

Associated with each of the categories is a pull down menu 88 that displays the content selections 36 as shown in FIG. 26. In the context of “The Honeymooners,” the content selections 36 are the episodes “The Sewer Rat,” “The Man from Space,” “The Bus Broke” and the like. Each content selection 36 is associated with a specific price 90. Other additional information 92 may also be displayed associated with each content selection 36. In this embodiment, the webpage displays the date on which the episode of “The Honeymooners” was originally aired.

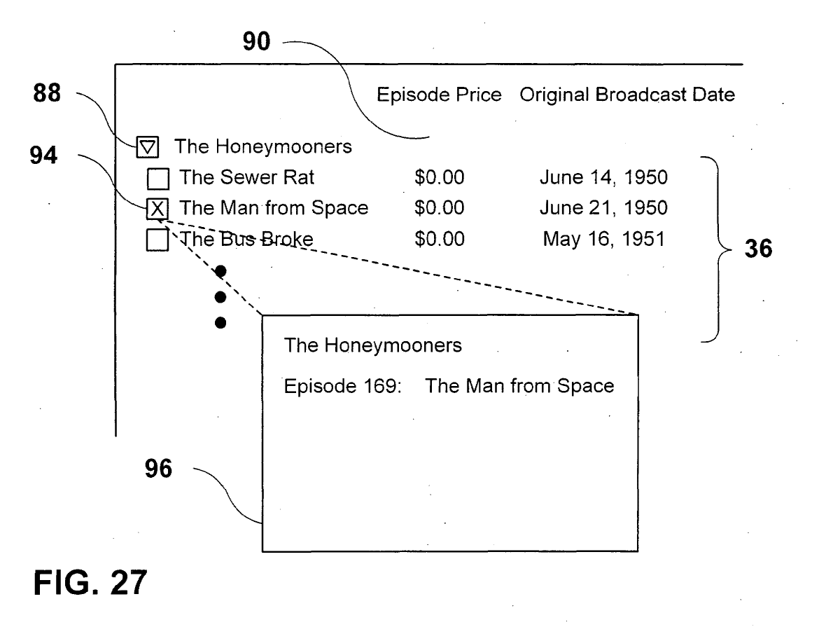

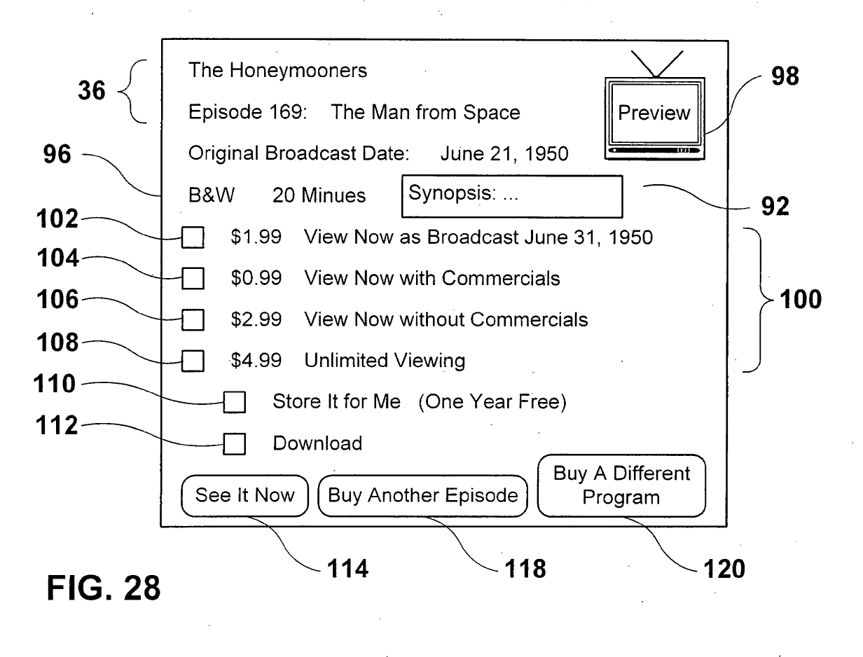

As shown in FIG. 27, the user 14 chooses a content selection 36 by clicking on the box 94. A pop-up box 96 appears as shown in FIG. 27. The contents of the pop-up box 96 are shown in FIG. 28. The pop-up box 96 provides information about the content selection 36, for example, that “The Man from Space” was episode “169,” that it was filmed in black and white (B&W) and had a running time of twenty minutes. The user 14 can click the “Preview” button 98 to see a short segment of the selected content 36. The pop-up box 96 also presents purchase options 100. In the embodiment shown in FIG. 28, the user 14 may choose to view the content selection 36 as broadcast on June 21, 1950 102, with present day commercials 104. As alternatives, the content selection 36 may be viewed without commercials for a higher price 106, or may the user may pay for unlimited viewing 108.

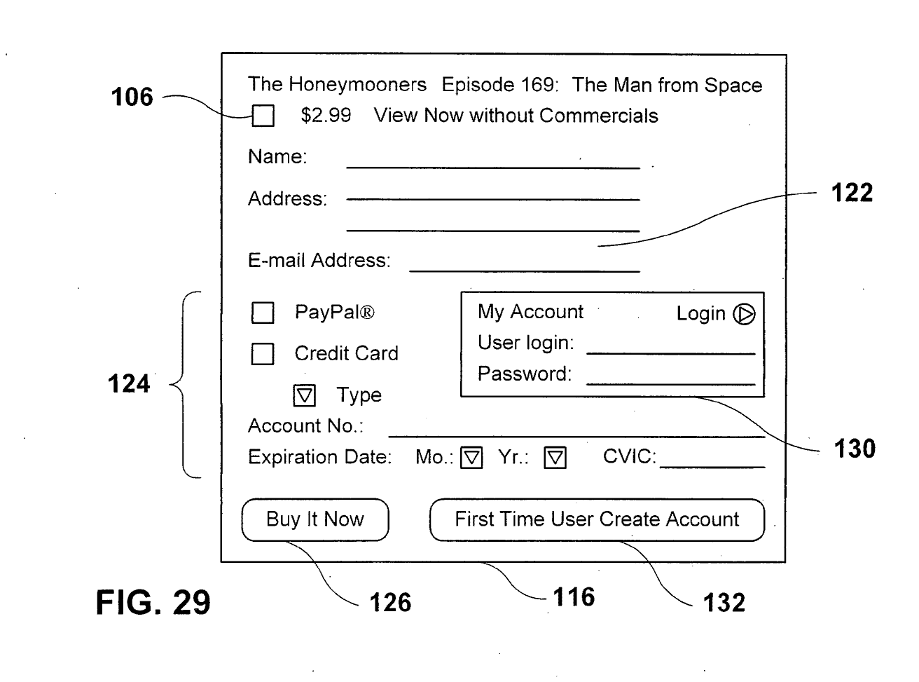

If the user 14 chooses to purchase the content selection 36 for unlimited viewing, he or she can elect 110 to have the episode stored in the network cache 26 for some duration or have it downloaded 112 to a user's 14 content terminal 18. If the user 14 clicks the “See It Now” button 114, he or she will be taken to another Web site screen for payment 116 as shown in FIG. 29. If the user 14 clicks the “Buy Another Episode” button 118, he or she will be taken to the pull down menu 88. If the user 14 clicks the “Buy A Different Program” button 120, he or she will be taken back to the Web site home page 82.

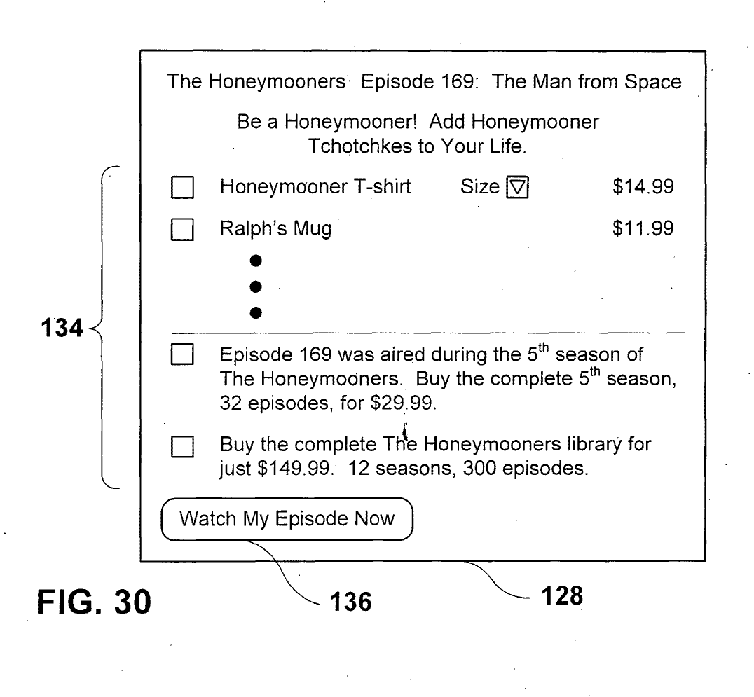

The payment screen 116 includes an area for the user 14 to enter his or her personal information 122 and payment options 124. The user 14 enters his or her personal information 122 and selects a payment option 124. Completing these two steps, the user 14 clicks the “Buy It Now” button 1266. Once the user's 14 personal information 122 and payment information 124 is verified, another screen 128 is provided to begin viewing as shown in FIG. 30.

The payment screen 116 also provides for an account login 130 for those users 14 who have registered previously, as well as a button to create an account 132 for first time users 14. If a first time user 14 clicks button 132 to create an account, a pop-up screen is provided for entering his or her personal information 122 and form of payment 124. The user 14 also creates a login name and password for accessing his or her account login 130 in the future. After creating or accessing an account login 130, the user 14 is returned to the payment screen 116 with his or her account information completed on the screen 116. The user 14 clicks the “Buy It Now” button 126 and is taken to the begin viewing screen 128 as shown in FIG. 30.

In addition to providing a means for beginning to view the content selection 36, “The Man from Space” episode of the “The Honeymooners,” the viewing screen 128 enables the sale of additional items 134. If the user 14 chooses any of the additional items 134, the purchases are added to his payment. The user 14 clicks button 136 to begin viewing the selected content 36.

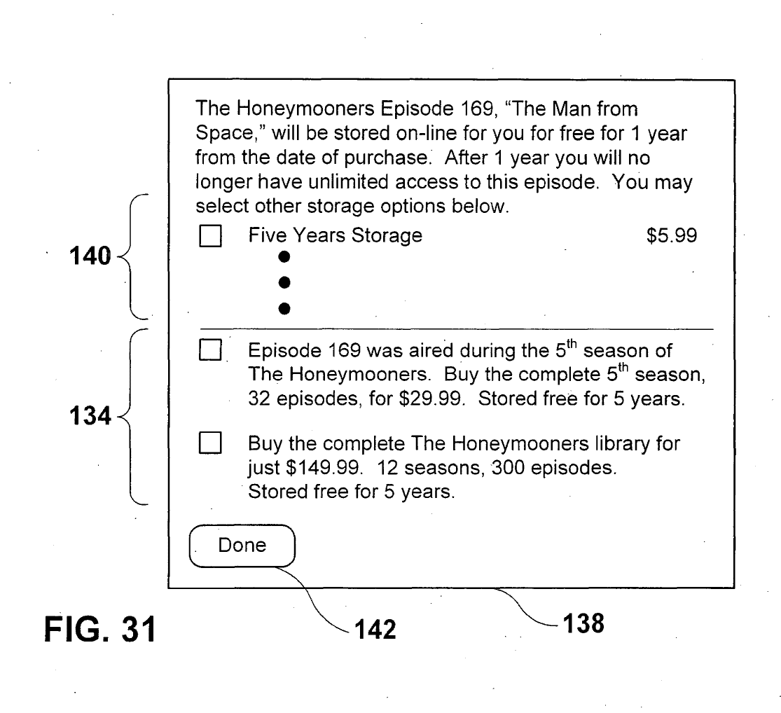

If the user 14 selects the “Store It For Me” option 110 in FIG. 28, he or she is directed to a storage options screen 138 as shown in FIG. 31. The storage options screen 138 offers storage options 140 as well as opportunities for selling additional items 134. The “Done” button 142 takes the user 14 back to the pop-up box 96 shown in FIG. 28.

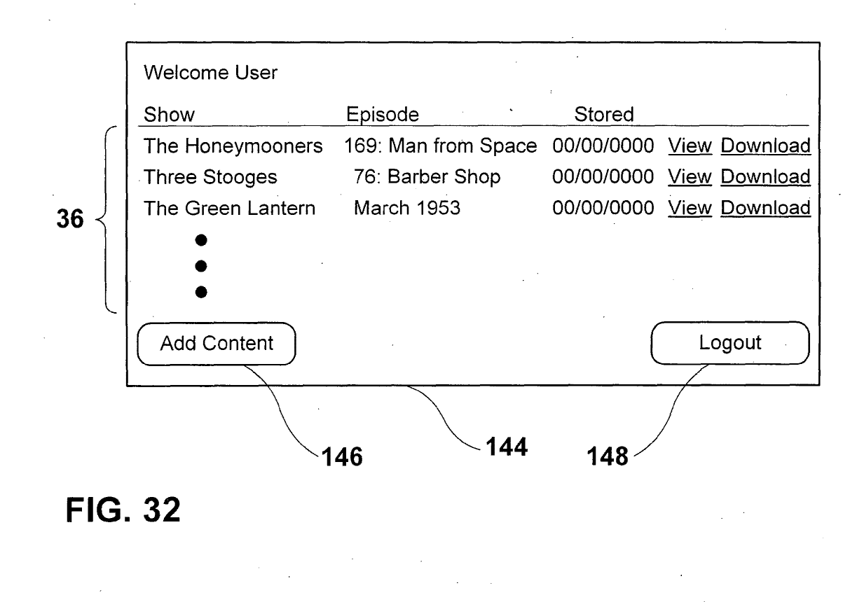

The user 14 who has stored content selections 36 can always access his or her media by logging into his or her account 130. The user's account is displayed 144 as shown in FIG. 32. The user's stored selected content 36 is displayed. The user 14 can view or download any stored selected content 36. A user 14 can add selected content 36 to his or her account by clicking the “Add Content” button 146, which takes the user 14 to the Web site home page 82 as shown in FIG. 23. When done, the user 14 can logout using button 148.

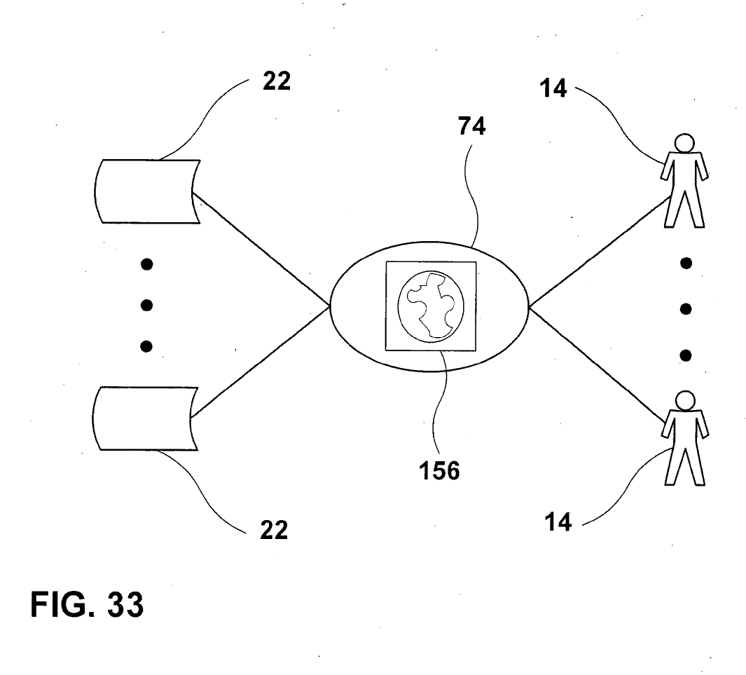

FIG. 33 shows a preferred embodiment of the invention. Content providers 22 make content selections 36 available to an intermediary 74 that builds and maintains the Web site 150 that makes the content selections 36 available to users 14 as described above.

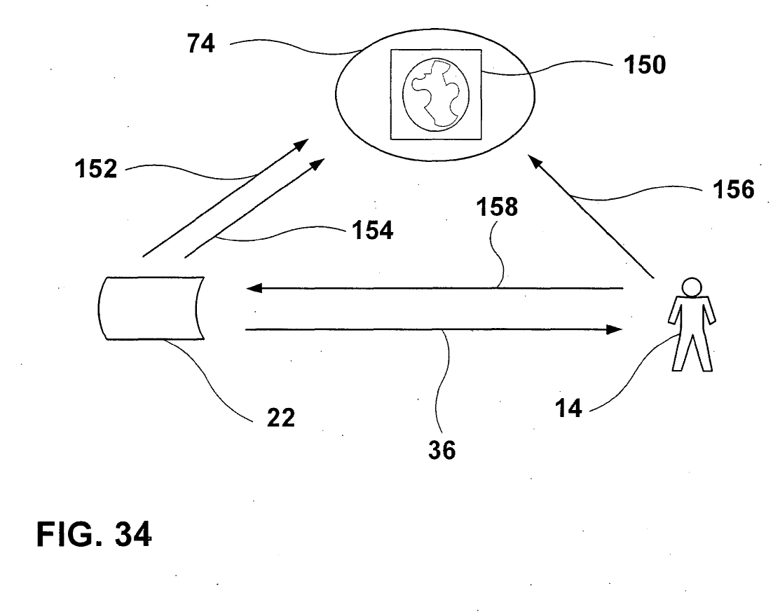

FIG. 34 depicts one method of the invention. A content provider 22 provides a listing 152 of content selections 36 to the intermediary 74 and pays a fee 154 to the intermediary 74 listing the content selection 36 on the Web site 150, particularly the Web site home page 82. The user 14 shops 156 on the Web site 150. When the user 14 makes a content selection 36 and purchases content selection 36 on the Web site 150, the user's payment 158 goes directly to the content provider 22 who makes the selected content 36 available to the user 14. In this embodiment of the invention, the intermediary 74 solely provides and maintains the Web site 150. The content provider 22 stores its own content 36 and makes it available directly to the user 14 whether immediately or over an extended period of time.

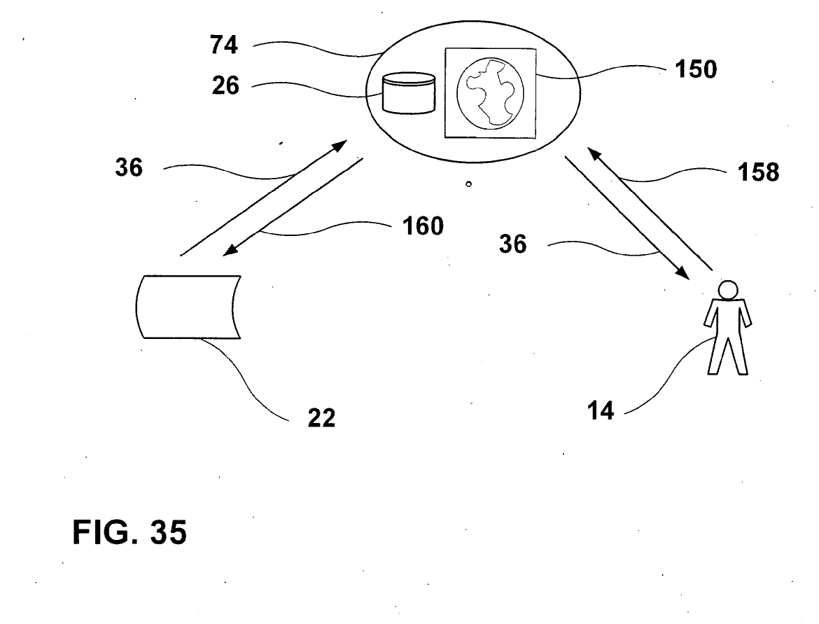

FIG. 35 depicts a second method of the invention. In this embodiment, the intermediary 74 acquires content_{,} selections 36 from content providers 22 for which the intermediary 74 pays fees 160 to the content providers 22. The intermediary 74 stores the content selection 36 in a network cache 26 that the intermediary 74 operates and maintains. When the user 14 purchases a content selection 36 on the Web site 150, the user's payment 158 goes to the intermediary 74 who makes the selected content 36 available to the user 14 from the network cache 26.

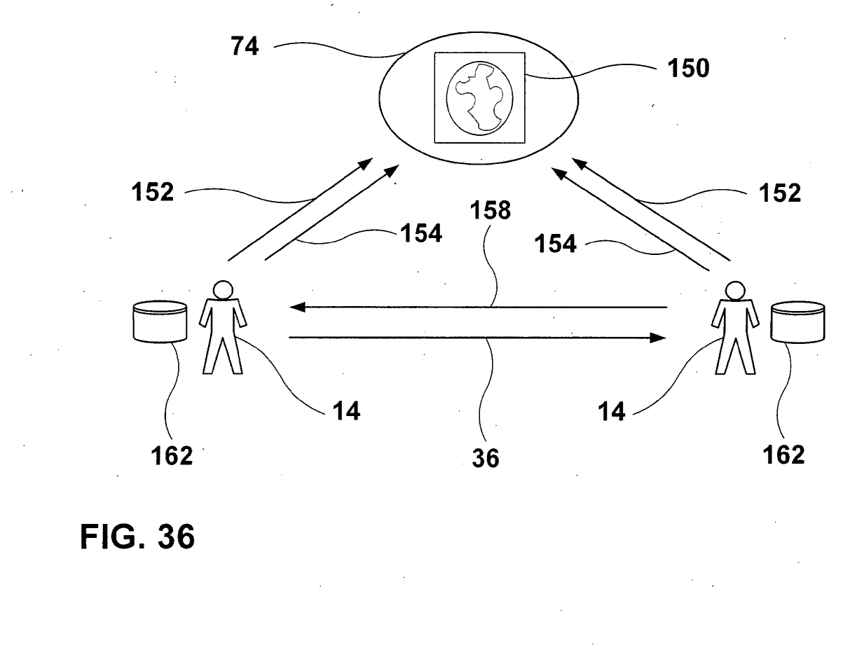

FIG. 36 depicts a third method of the invention. In this embodiment, users 14 provide listings 152 of content selection 36 to the intermediary 74, and pay a fee 154 to the intermediary 74 for displaying the user's content selections 36 on the Web site 150. When a first user 14a wants to acquire content selections 36 from a second user 14b, the second user 14b provides the selected content 36 from his or her own cache 162. The first user 14a pays 158 the second user 14b directly.

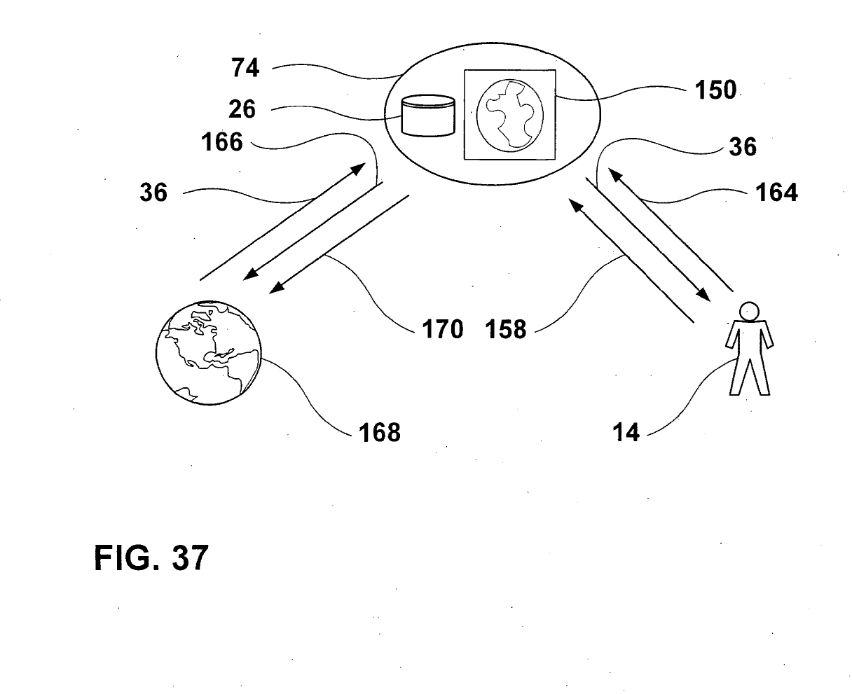

FIG. 37 depicts a fourth method of the invention. In this embodiment, a user 14 requests 164 that the intermediary 74 find the user's 14 selected content 36. The intermediary 74 searches 166 the world 1168 for the selected content 36 and upon locating it, acquires the selected content 36. The intermediary 74 pays 176 for the selected content 36 it acquires and provides it 36 to the user 14. The user 14 then pays 158 the intermediary 74 for the selected content 36.

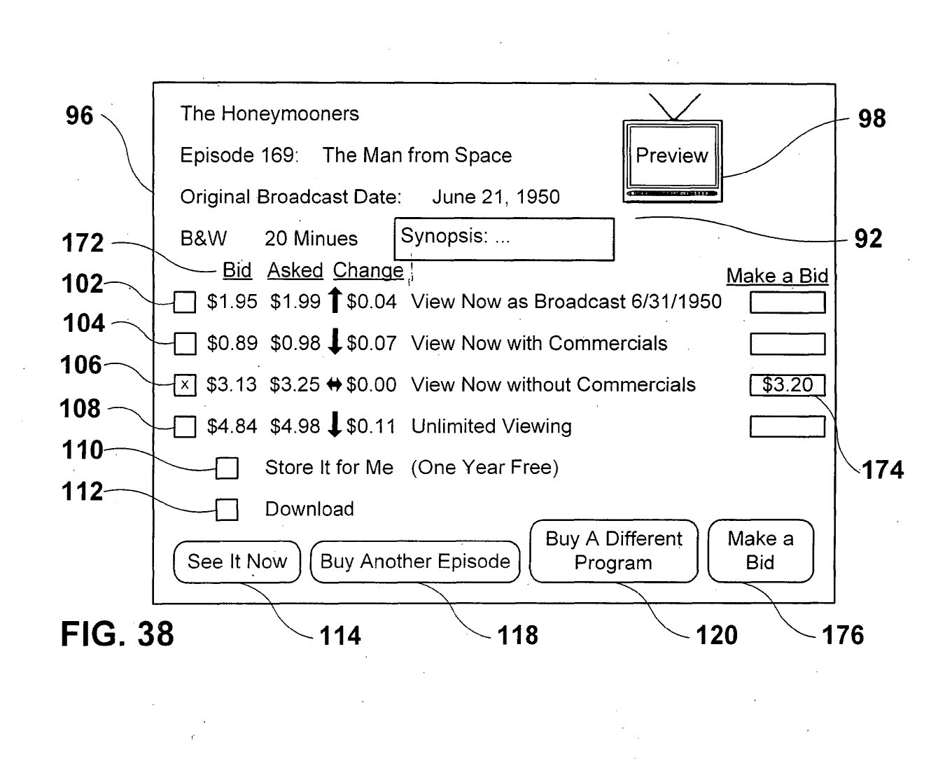

A fifth method of the invention introduces a trading exchange based upon free market principles. In a first trading exchange embodiment, content providers 22 display categories of content selections 36 on the Web site home page 82 as described above. A user 14 selects content 36 as shown in FIG. 27. However, in the instant embodiment rather than a predetermined price 90 being displayed market prices 172 are displayed. Thus, in the instant embodiment FIG. 28 becomes FIG. 38.

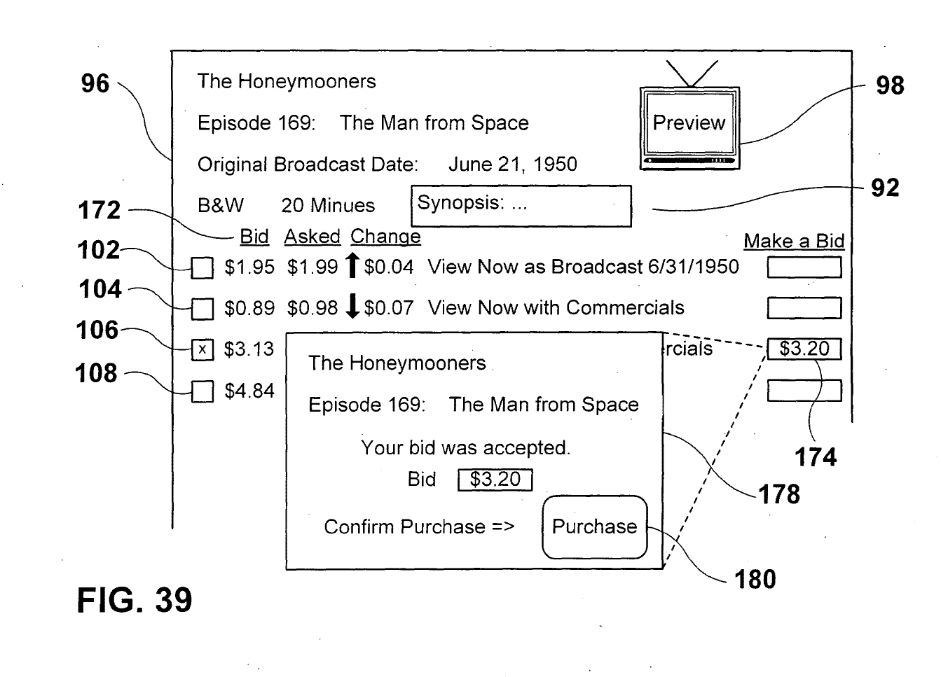

A user 14 makes a bid on a content selection 36 by entering an amount in box 174 and clicking the “Make a Bid” button 176. If the bid is accepted a pop-up box 178 appears as shown in FIG. 39. The user 14 confirms his or her purchase by clicking the “Purchase” button 180. Confirming the purchase takes the user 14 back to FIG. 38.

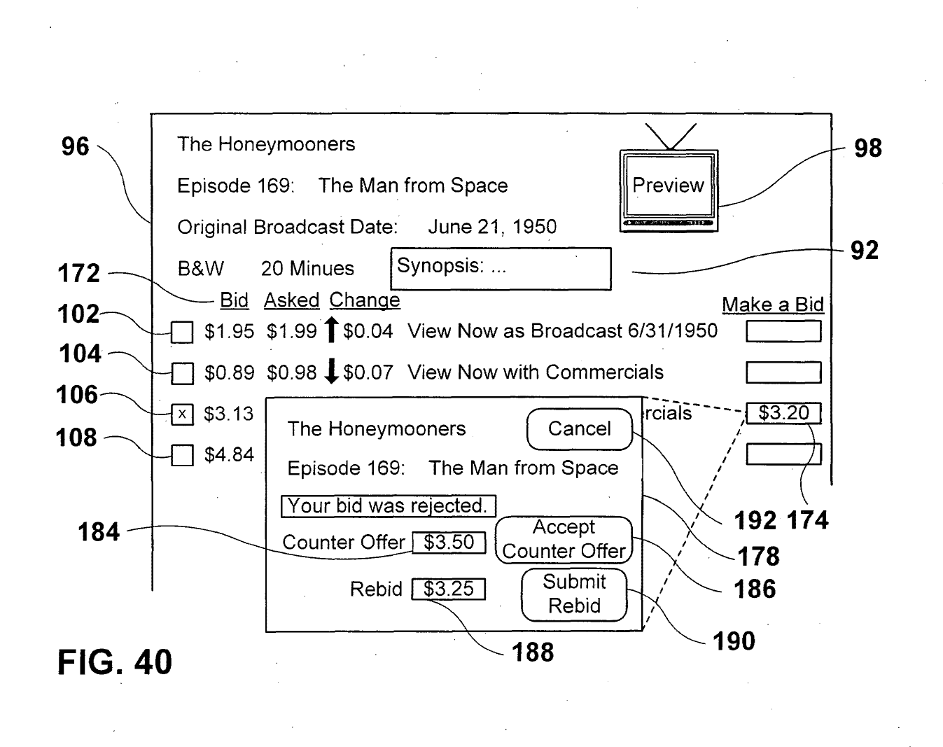

If the bid is not accepted a pop-up screen 182 appears as shown in FIG. 40. A counter offer price 184 is displayed. A user can accept this price by clicking the

“Accept Counter Offer” button 186 or make a different bid by entering it into box 188 and clicking the “Submit Rebid” button 190. If the counter bid is accepted, the user 14 sees the pop-up box 178. If it is again rejected, pop-up box 182 appears again, perhaps with a new counter offer price 184. The user 14 can elect to cancel the transaction by clicking the “Cancel” button 192, which takes the user 14 back to FIG. 38.

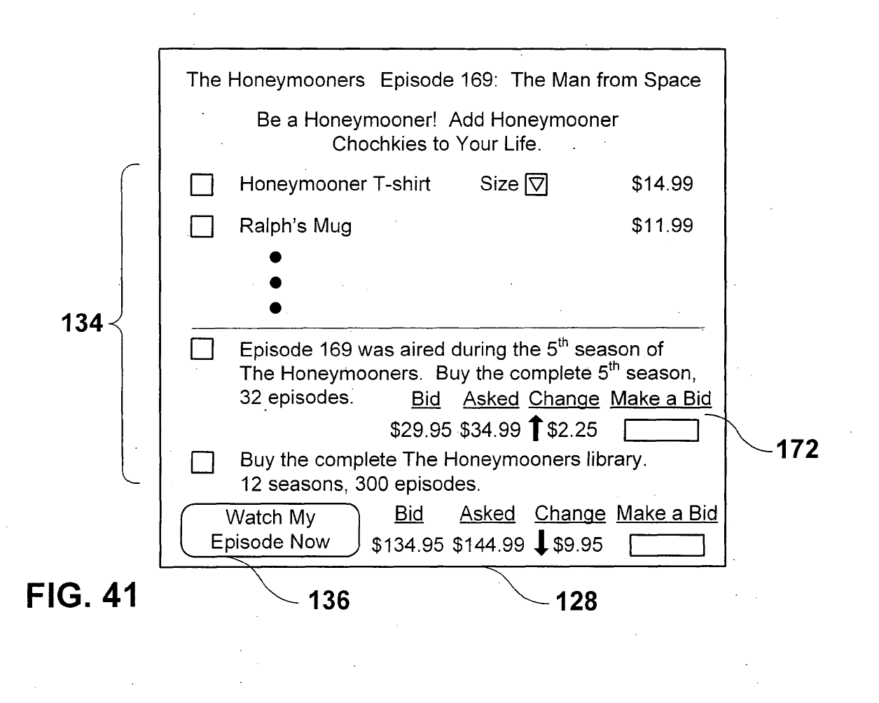

Analogously, FIG. 30 becomes FIG. 41 in the instant embodiment. Here too fixed prices 90 are replaced with market prices 172. If the user 14 makes a bid on either the full season or the complete library as shown in FIG. 41, either pop-up box 178 or 182 appears. Market prices 172 would also be substituted for fixed prices 90 in FIG. 31 as well.

The “trading embodiment” described thus far may be characterized as a “retail” embodiment, the user 14 is the consumer of his or her content selections 36. A second “trading embodiment” may be characterized as “wholesale,” as shown in

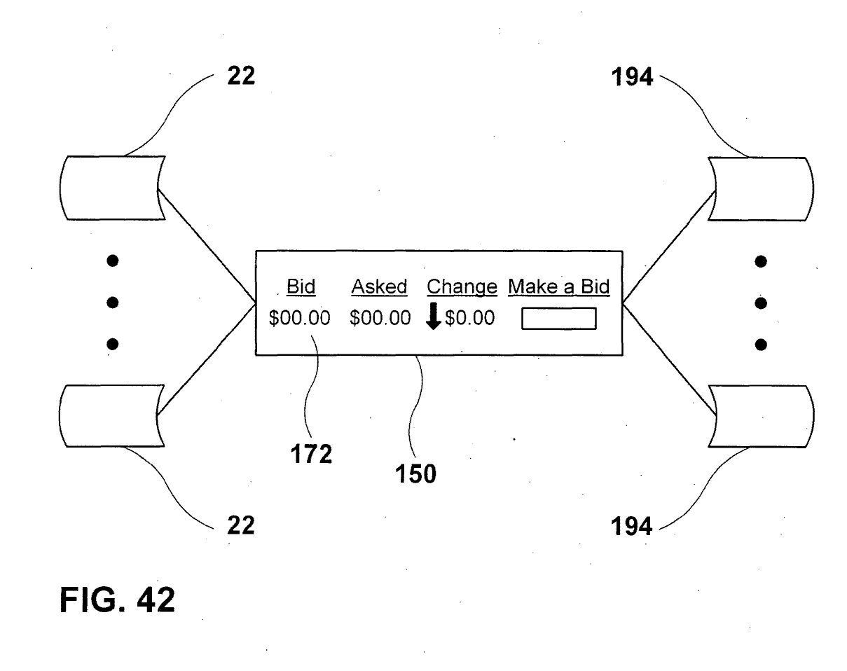

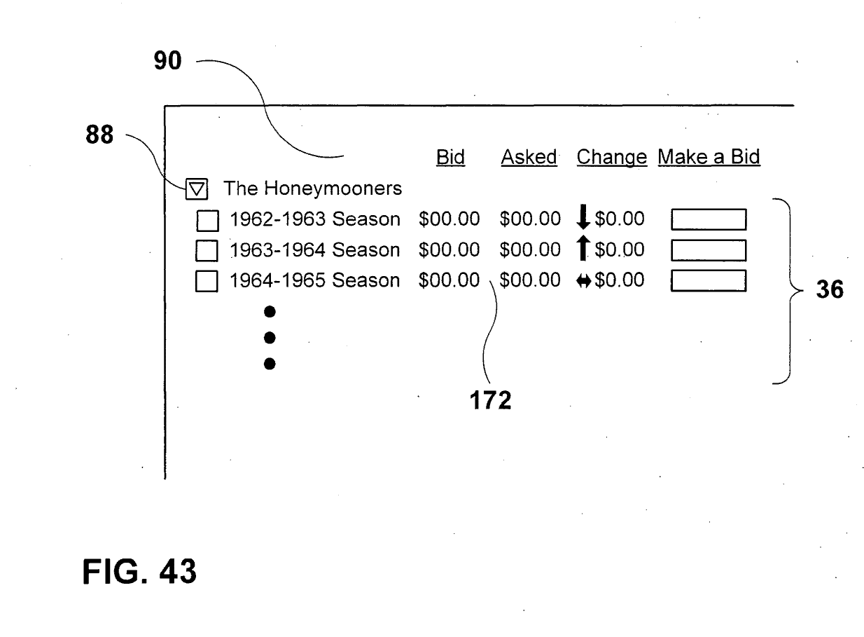

FIG. 42. Media content distributors 194, including but not limited to television networks, cable networks, radio networks, magazine publishers, satellite television providers and the like, can bid on collections of content selections 36 from content providers 22, including but not limited to record companies, Hollywood studios, television syndicators, independent producers, book publishers, graphics images providers and the like, using the technologies of the invention. For the instant “wholesale” embodiment FIG. 26 becomes FIG. 43.

While FIG. 43 shows bid and asked prices 172 in a lump sum for the content selection 36, media content distributors 194 may also bid on per viewer basis.

### V. Scheduling Content Delivery

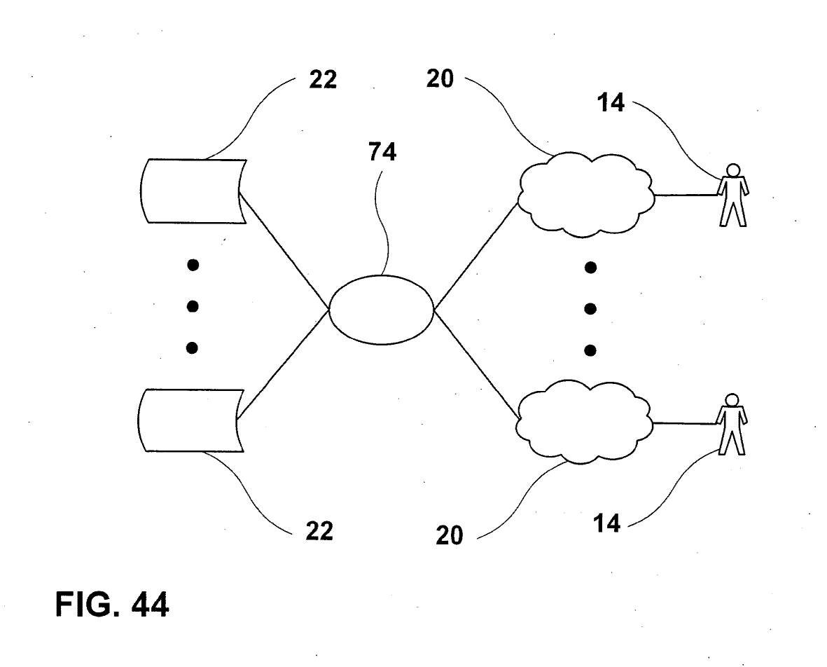

FIG. 44 illustrates methods and apparatus for a user to select and have delivered to him or her content selections 36 at his or her choice of time, location and means. An intermediary 74 negotiates with content providers 22 to make content selections 36 available on demand, whether that media comprises music, audio files, videos, continuing education programs, text files, documents, news, television shows, newspapers, magazines, professional journals, electronic books (e-books) and the like. The content selection 36 may be full content or it may be condensed, abstracted or otherwise simplified. The intermediary 74 likewise negotiates with networks 20 to provide access to users 14 and to deliver content selections 36 to users 14.

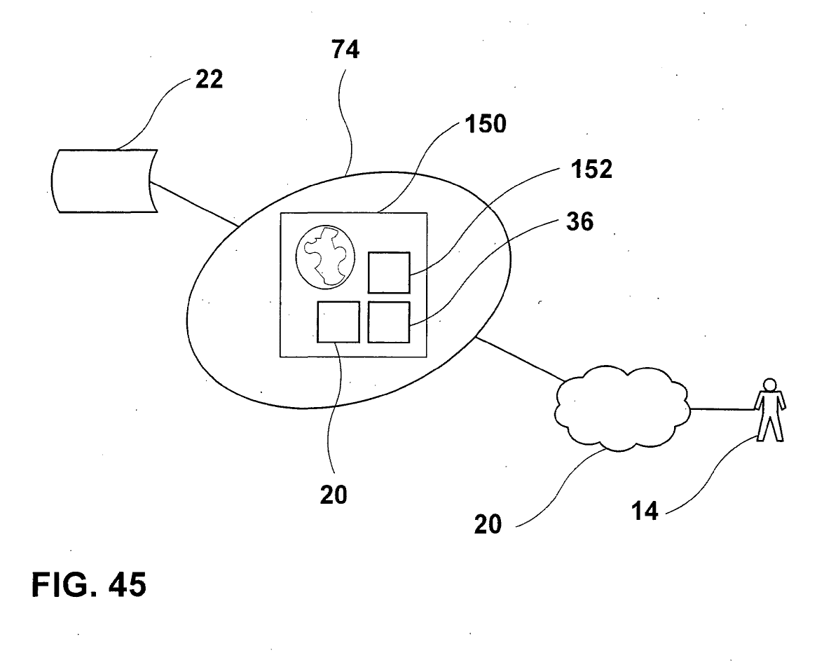

In a preferred embodiment of the instant invention, the intermediary 74 lists content selections 152 and available delivery networks 20 on a Web site 150 as shown in FIG. 45. A user 14 accesses the Web site 150 via a network 20 to make his or her content selections 36 as well as to direct which network 20 is to be used to deliver the content selection 36.

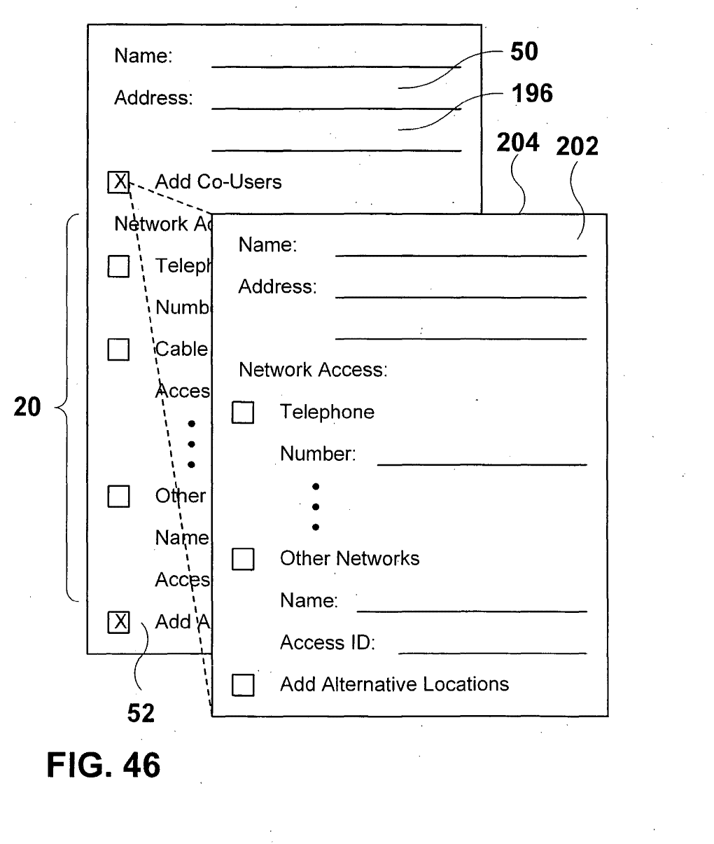

When the user 14 first accesses an embodiment of the instant invention, he or she provides registration information on the Web site 150 as shown in FIG. 46. Among the information the user 14 registers is his or her home location 50 and any alternative locations 52. Embodiments of the invention use the home location information 196 and alternative location information 198 for time zone 200 information. The user 14 also registers any networks 20 to which he or she has access. The user 14 may likewise register additional co-users 202 such as family members and work colleagues, as well as the networks 20 to which they have access, one embodiment of which is a pop-up box 204.

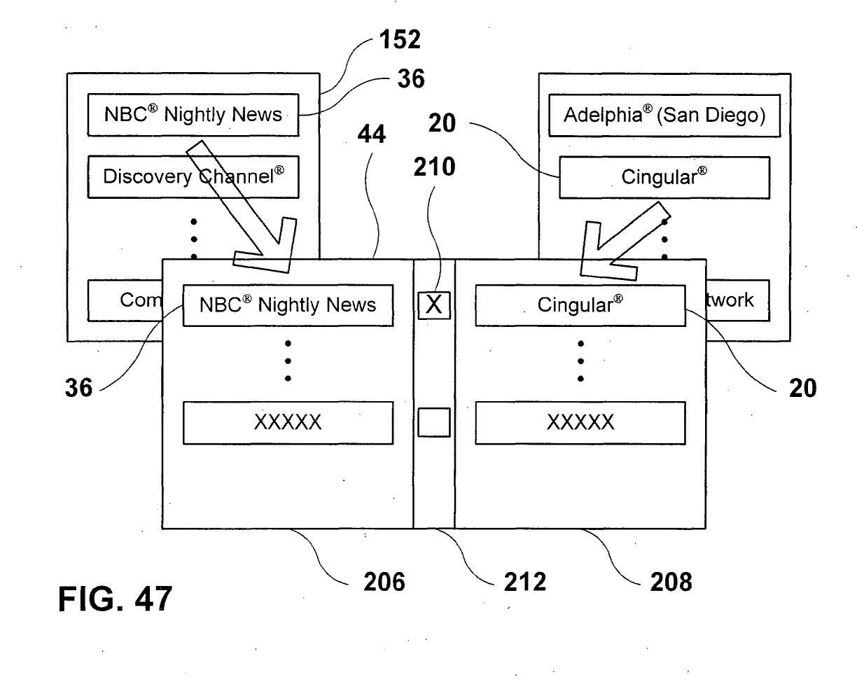

The first step in the process is for the user 14 to associate content selections 36 with available delivery networks 20. One embodiment to accomplish this is shown in FIG. 47. The user 14 drags a content selection 36 onto a first panel 206 of his or her content schedule 44. Then the user drags a network selection 20 onto a second panel 208 of the programming schedule 44, aligning the network selection 20 with the content selection 36. To initiate the association, the user 14 performs an associative act by clicking a box 210 in a third panel 212 on the programming schedule 44.

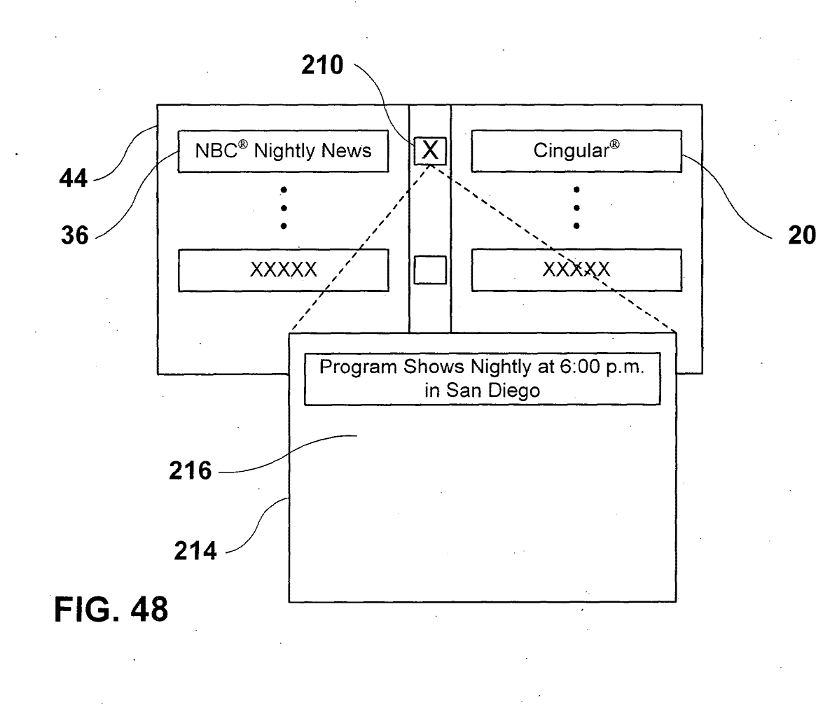

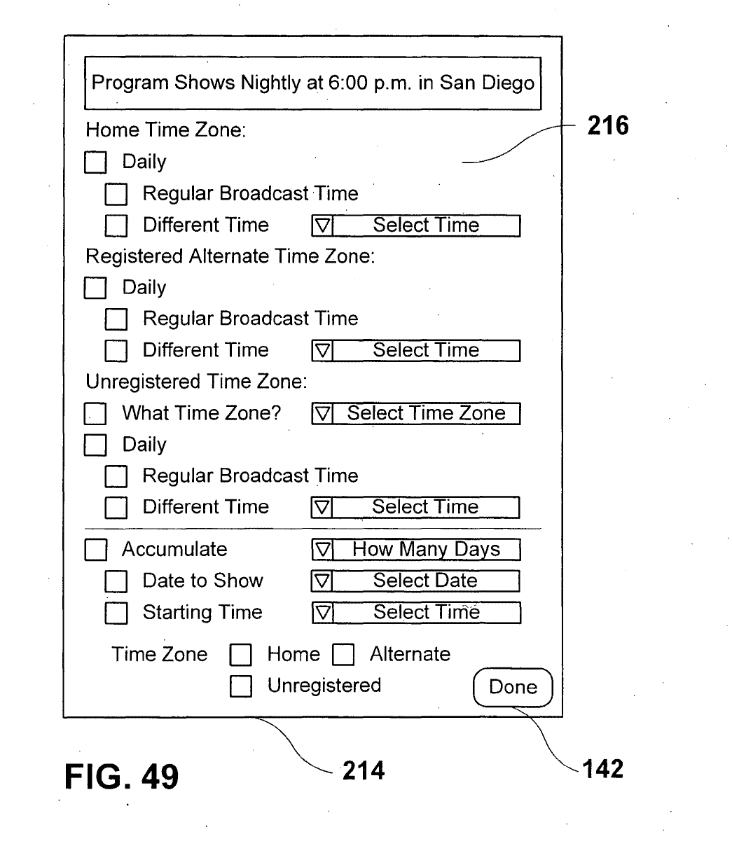

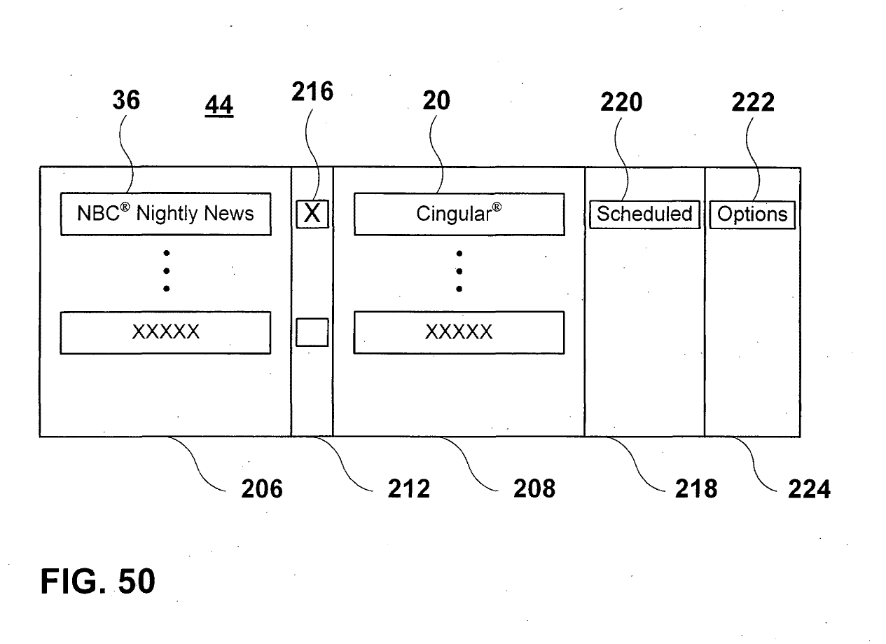

A further embodiment of this process is shown in FIG. 48. When the user 14 performs the associative act of checking the box 210, a pop-up box 214 appears displaying schedule options 216 as shown in FIG. 49. When the user 14 is finished scheduling his or her content selections 36, he or she closes the pop-up box 214 by clicking the “Done” button 142. Whereupon a fourth panel 218 is added to the content schedule 44 with the notation “Scheduled” 220 appearing aligned with the content selection 36 as shown in FIG. 50. Clicking on the “Scheduled” 220 takes the user 14 back to the pop-up box 214.

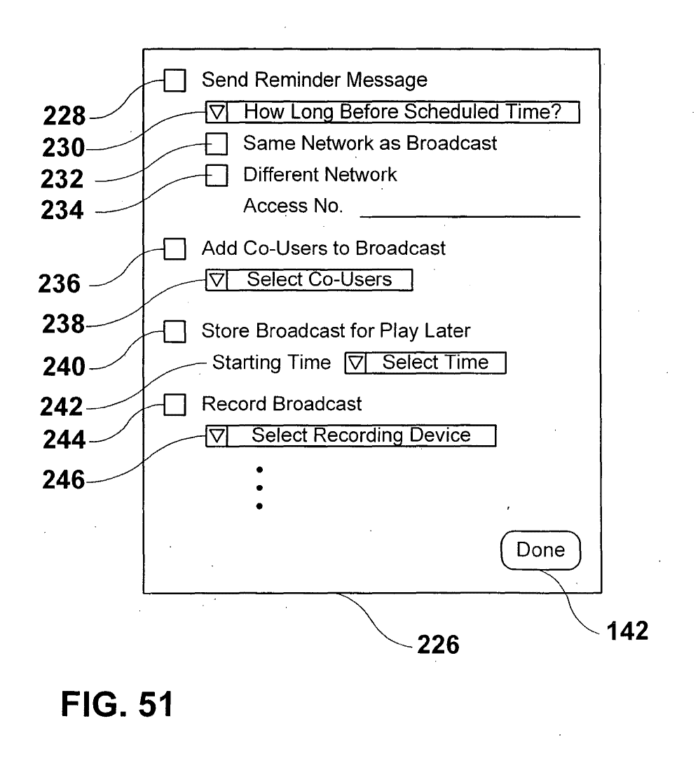

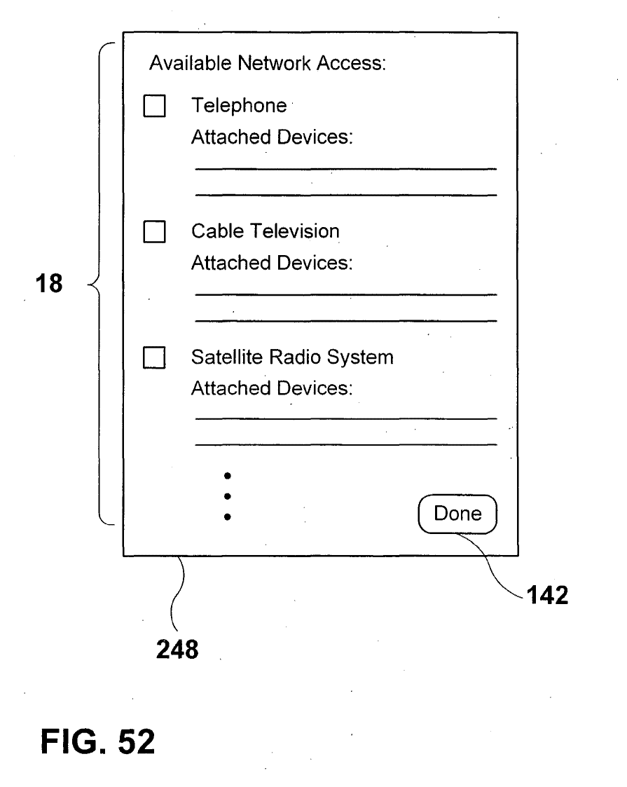

The user 14 can register further content scheduling instructions by clicking on the “Options” notation 222 in a fifth panel 224 of the content schedule 44 as shown in FIG. 50. Clicking on the “Options” notation 222 opens the pop-up box 226 shown in FIG. 51.

An embodiment of options comprises having a reminder message 228 sent before the time scheduled 216 for the content selection 36 to be played. A drop down menu 230 displays minutes before the scheduled time at which the reminder message 228 will be sent. The user 14 can have the reminder message 228 sent over the same network as scheduled 20 by clicking box 232 or redirecting the reminder to a different network 20 by clicking box 234 and entering the address of the new network 20.

The user 14 can elect 236 to have other co-users 202 receive the content selection 36. A drop down menu 238 lists the co-users 202 registered in pop-up box 204.

The user 14 can elect 240 to store the selected content 36 in the network cache 26 for later play or viewing. A drop down menu 242 displays times the user can select.

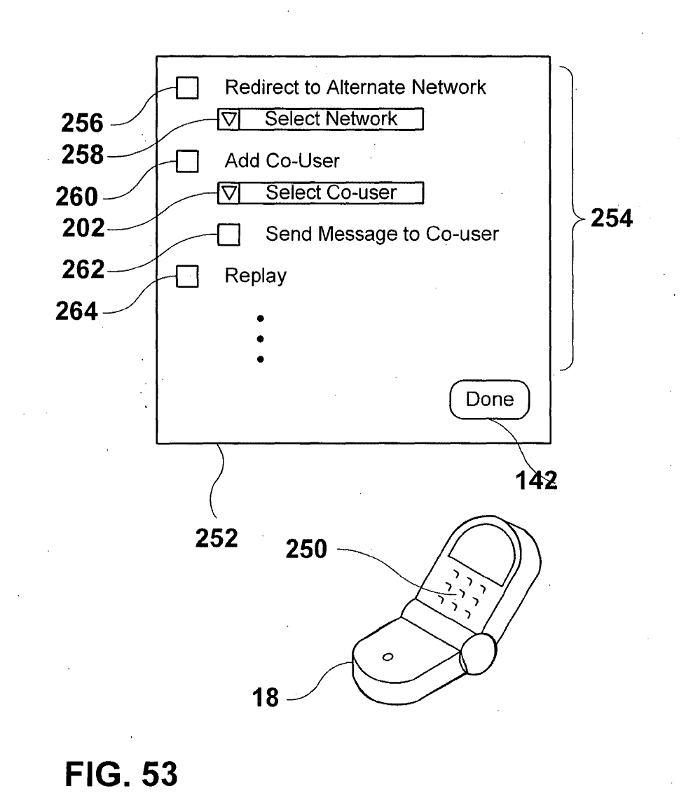

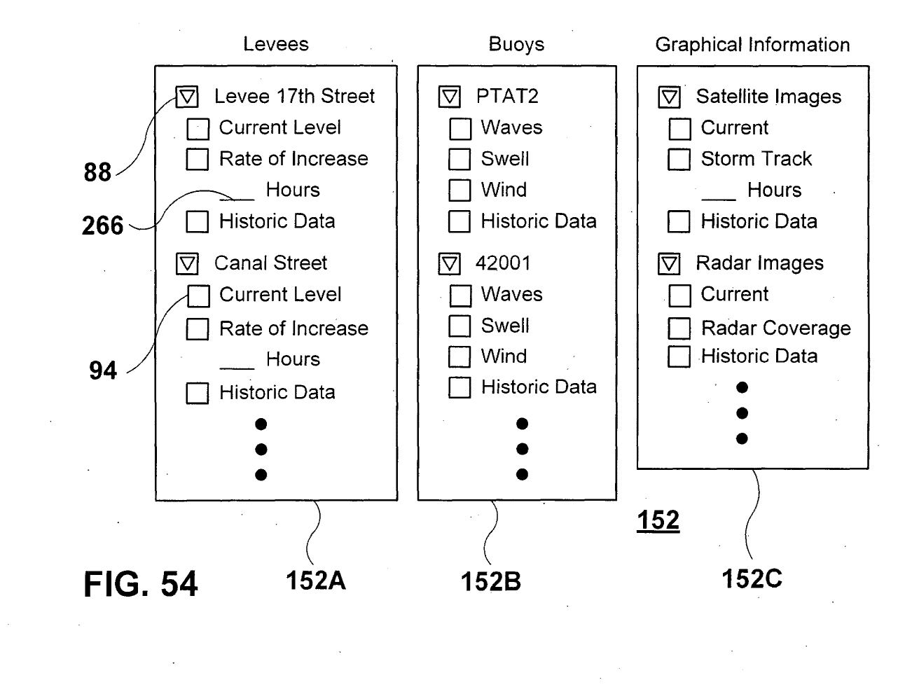

The user 14 can elect 244 to record the content selection 36. A drop down menu 246 displays available recording content terminals 18. The first time the user 14 clicks the drop down menu 246, a pop-up box 248 appears enabling the user 14 to enumerate the content terminals 18 attached to an available delivery network 20 as shown in FIG. 54. During the delivery of content selection 36 a user 14 can enter a code 250 into his content terminal 18 to bring up a pop-up box 252 enabling the user 14 to take actions 254 as shown in FIG. 53. The user 14 can redirect the broadcast 256 to another network 20 by selecting an available network 20 from the pull down menu 258. He or she can said a co-user 202 to the broadcast of the content selection 36 by selecting a co-user 202 from the pull down menu 260, as well as send an alerting message 262 to the co-user. The user 14 can replay 264 the broadcast of the content selection 36.

A preferred embodiment of the invention registers all of the scheduling actions and options described into a SIM 30.

### VI. Alternative Embodiments of the Invention

One implementation of the present invention is for disaster response. First and early responders 14 can acquire and schedule content selections 36 to aid in formulating and implementing responses to disaster. FIG. 54 shows listings of data 152 that would be important in responding to a hurricane on the United States Gulf Coast. Levee status 152A information is collected and disseminated by the U.S. Army Corps of Engineers. The National Oceanic and Atmospheric Administration (NOAA) operates a buoy network throughout United States coastal waters and makes this information 152B available via the Web. NOAA also operates weather satellites from which graphical images 152C are available. Radar images 152C are available from numbers of sources including the Federal Aviation Administration (FAA). Pull down menus 88 enable a user 14 to access additional data not shown on the face of the categories of content selection 36. A user 14 checks box 94 to select data. If the user 14 fills in the blank 266 he or she can access data that is aggregated over the desired period. The user 14 can schedule downloading of his or her content selections 36 as shown in FIG. 45 and as described above. FIG. 54 and some of the subsequent drawings show listings 152 of three categories of content selections 36.

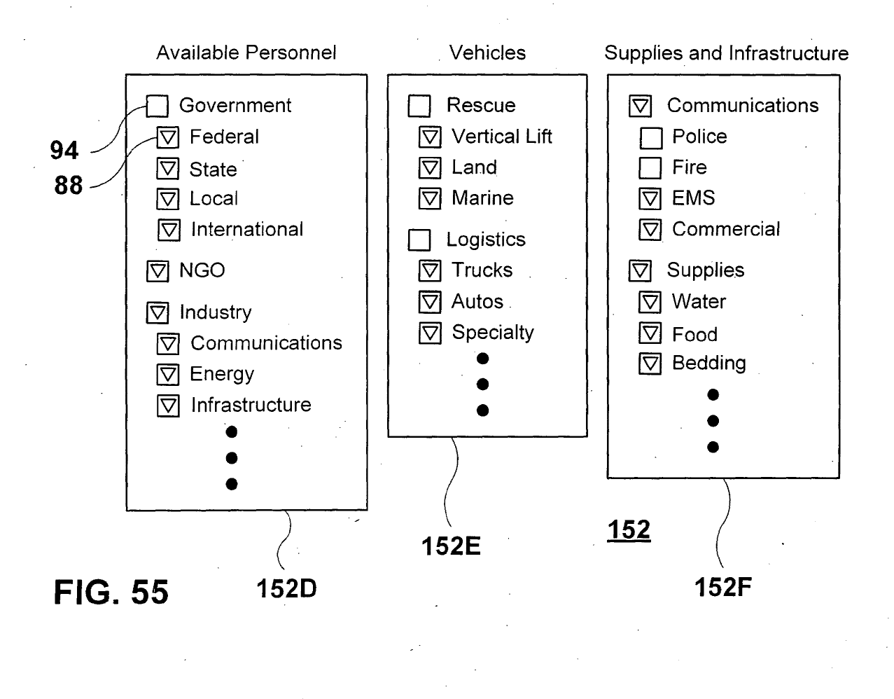

A second similar specific embodiment is logistical support in a disaster or emergency. FIG. 55 shows categories of data to support logistics operations in a disaster or emergency. There are a myriad of agencies that respond to disasters or in emergencies, Federal, State, local, Non-Governmental Organizations (NGOs). Private industry is also engaged. All of the agencies and industry can publish lists of their available personnel 152D as shown in FIG. 55. Available vehicles can likewise be displayed 152E, along with information on supplies and infrastructure 152F. Pull down menus 88 enable a logistician 14 to access additional data not shown on the face of the categories of data. A logistician or other user 14 checks box 94 to select items of media content 36. The user or logistician 14 can schedule downloading of his or her content selections 36 as shown in FIG. 45 and as described above.

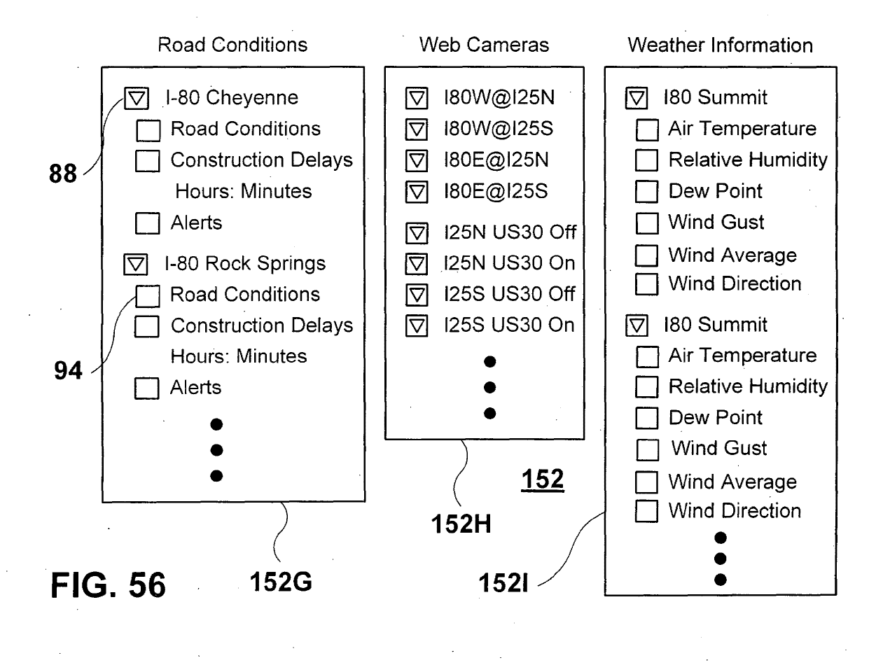

The nation's truck drivers are always looking for ways to avoid problems with weather, delays, road conditions and the like. The State of Wyoming has installed cameras along its Interstate Highways that are accessible via the Web. Many cities have installed cameras observing their major intersections. State highway departments are increasingly broadcasting road conditions via the Internet. A trucker driving along Interstate 80 in the State of Wyoming, may utilize the embodiment of the invention shown in FIG. 56. All of the categories of data shown in FIG. 56 are made available by the Wyoming Department of Transportation (WYDOT). A trucker 14 can select from road condition information 152G. Web cameras 152H and weather data 1521 to be displayed on his or her content terminal 18 all based upon where he or she is or will be in the future. Accessing pull down menus 88 leads to additional information of interest. The user 14 can schedule downloading of his or her content selections 36 as shown in FIG. 45 and as described above.

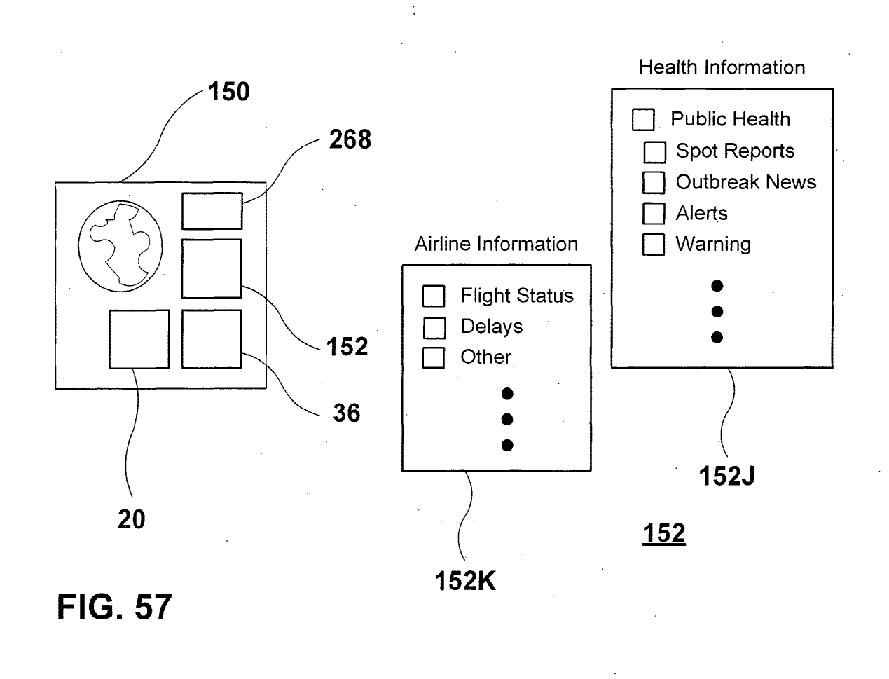

Air travelers, especially international, may benefit from a specific embodiment of the invention as shown in FIG. 57. The World Health Organization (WHO) and the United States Center for Disease Control (CDC) issue four types of notices to travelers 152J, ranging from spot reports on the appearance of diseases and “outbreak news” that lists each reported case of a specific disease. These escalate to alerts, which advise travelers to take special precautions when visiting certain areas. The highest level is the travel health warning, advising against all but essential travel into infected areas. A traveler 14 can register his or her itinerary 268 on the Web site 150 and have essential travel information 36 delivered to his or her content terminal 18 as shown in FIG. 47. The user 14 can receive health advisories 152J as well as airline flight information 152K as a result of registering his or her itinerary 268 on the Web site 150. The user 14 schedules downloading of his or her content selections 36 as shown in FIG. 45 and as described above to be available before the next leg of his or her itinerary 268.

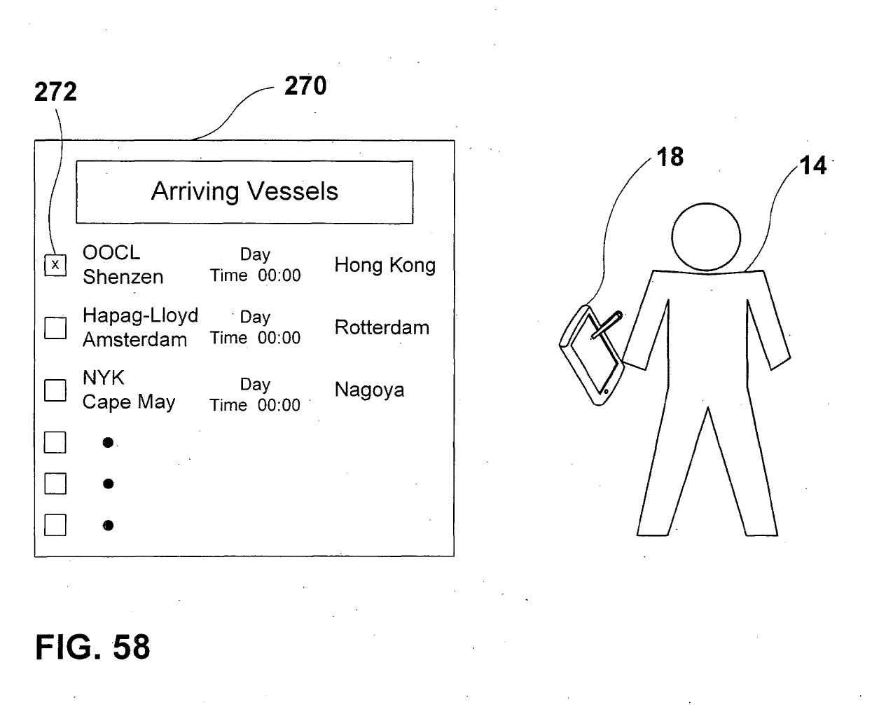

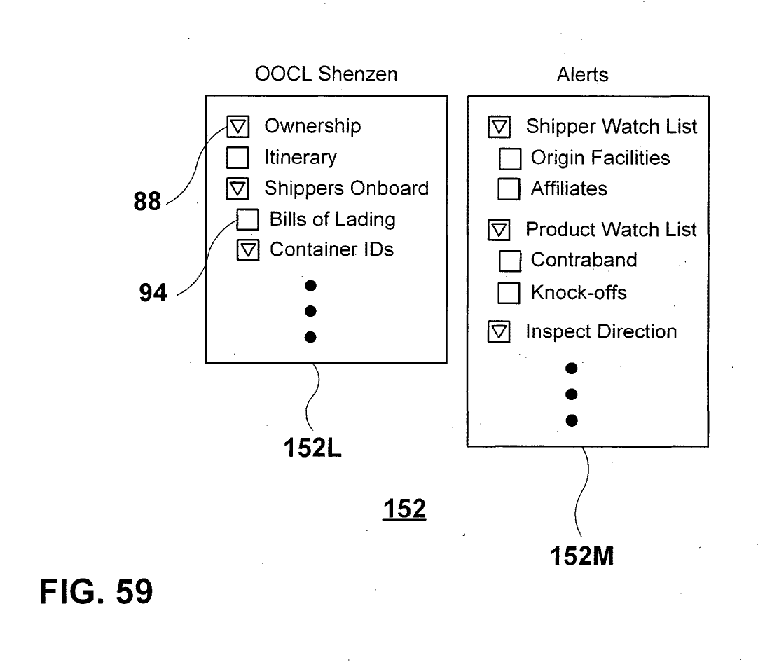

A further specific embodiment of the invention focuses on homeland security operations. Containers arriving at United States ports are inspected by personnel from the U.S. Department of Homeland Security (DHS). Inspectors are dispatched using content terminals 18. An inspector 14 in a port receives a list of arriving vessels 270 on his content terminal 18 as shown in FIG. 58. When the inspector 14 checks the box 272 in front of the name of a ship, his or her content terminal 18 sends a message back to a server informing his or her superiors at DHS that he or she is taking responsibility for inspecting the particular vessel upon arrival. The Web site 150 responds by displaying categories of data that may be of particular interest to the inspector 14 meeting the vessel selected by checking box 272. For example, vessel information 152L and alert status 152M may be displayed as shown in FIG. 59. The inspector 14 can select content 36 for delivery to his or her content terminal 18 at the times scheduled as shown in FIG. 45 and as described above.

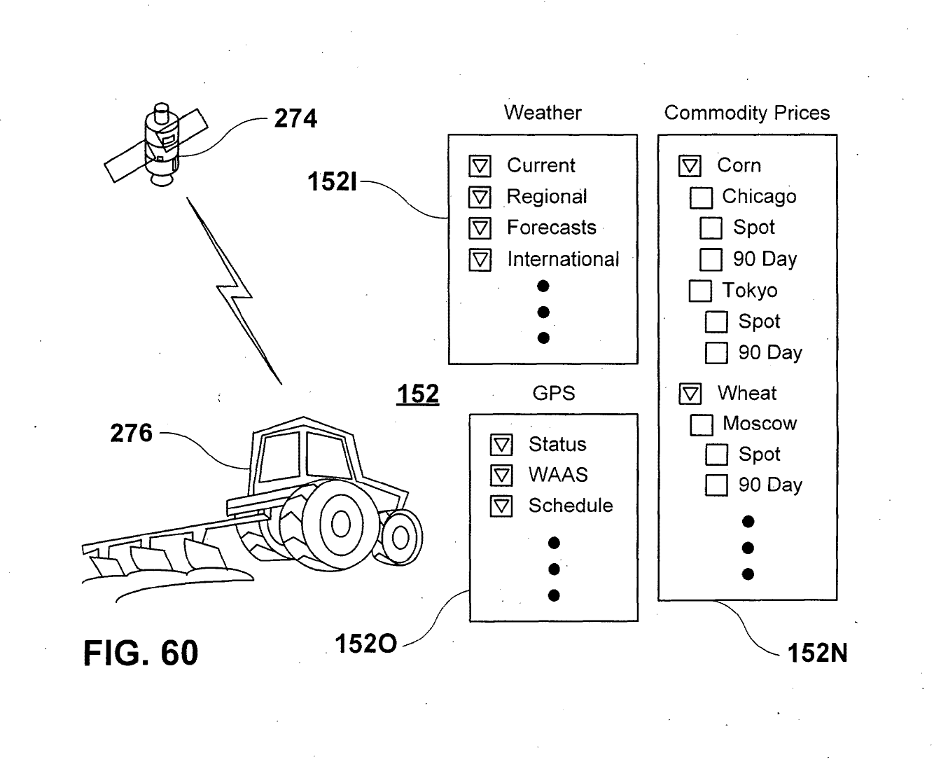

To survive farmers 14 today must do much more than just grow crops. They must be aware of commodity futures markets 152N, and the weather both locally and globally 1521. One of the most modern advances in farming is using the Global Positioning System (GPS) 274 to control the tractor 276 as it creates furrows in the field as shown in FIG. 60. Farmers 14, therefore, must be aware of the reliability and status of the GPS system 1520. A farmer 14 can schedule downloading of his or her content selections 36 as shown in FIG. 45 and as described above so that the content selection 36 is available while he or she 14 is plowing the fields.

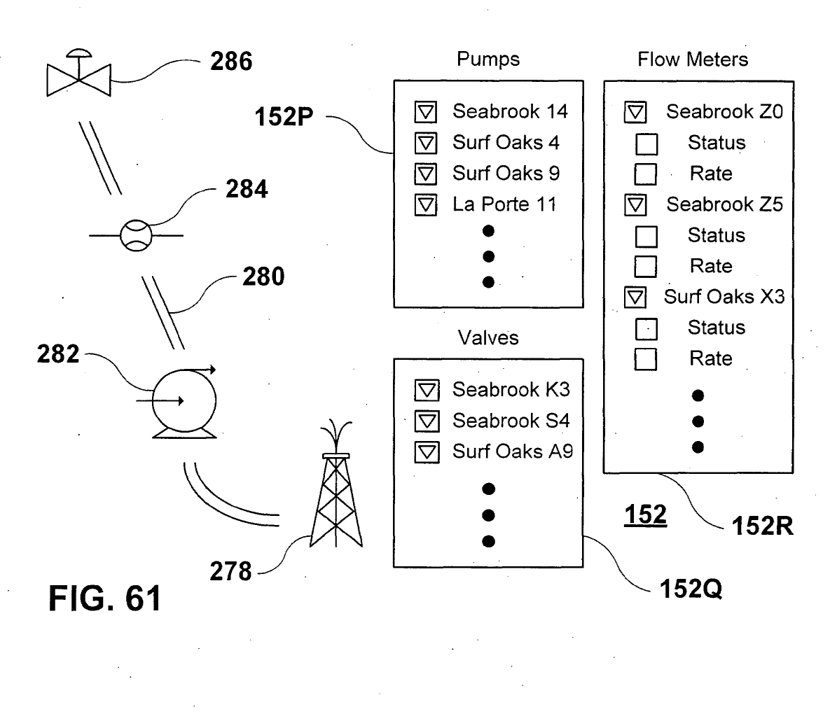

Supervision, Control and Data Acquisition (SCADA) systems are well known and in common usage in numbers of industries. SCADA systems typically comprise sensors attached to items or facilities of interest that collect data about the status and operation of the items or facilities. The collected data is transmitted to monitoring facilities via both wired and wireless networks 20. FIG. 61 shows an oil and gas industry SCADA application comprising a well 278 feeding a pipeline 280 through a pump 282, a flow meter 284 and a valve 286. A safety technician responsible for making sure there are no leaks in the line 280 or spills would be interested in receiving periodic reports on the status of elements in the SCADA system, which can be scheduled using a specific embodiment of the invention. For example, FIG. 61 shows listing of media content 152 relating to pumps 152P, valves 152Q, and flow meters 152R. A technician 14 can schedule downloading of his or her content selections 36 as shown in FIG. 45 and as described above.

Surveillance systems comprise pluralities of categories of data of interest.

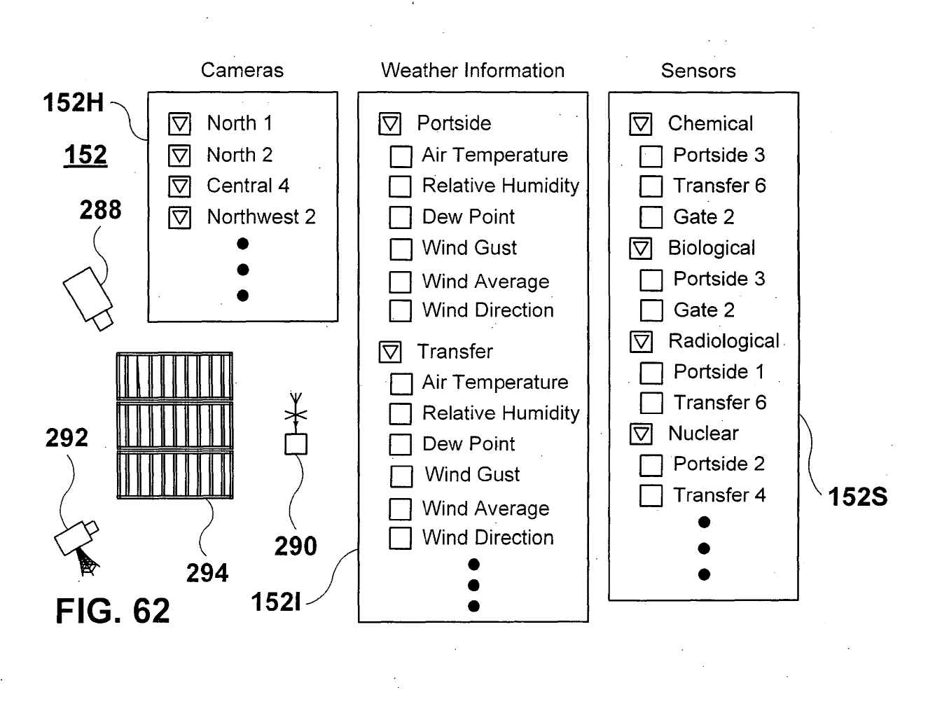

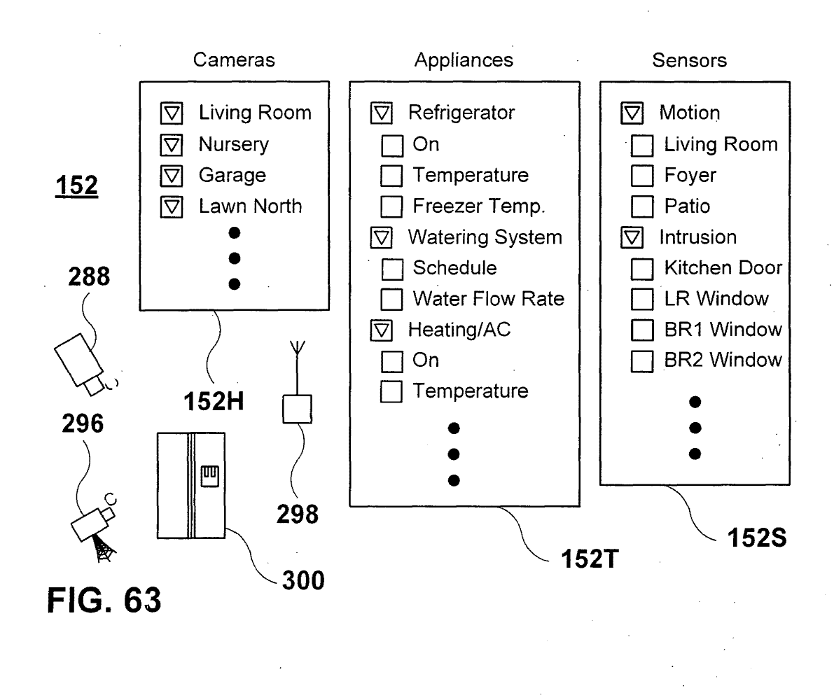

Users 14, both on-site and off-site, can select and schedule data downloads as shown in FIG. 45 and as described above. FIG. 62 shows a camera 288 and two sensors, an electromagnetic emissions sensor 290 and a radiological sensor 292 deployed in a port to observe and sense cargo containers 394. An inspector 14 may be interested in viewing cameras 152H and readings from sensors 152S. Because cameras and sensors are both potentially impacted by weather effects, a user 14 may also want weather data 1521.

Analogously to the embodiment above relating to cameras and sensors in a port, a home owner 14 may want to access data relating to his or her home on a regular basis. A home owner 14 may deploy cameras 288 throughout his or her home and/or property. He or she may deploy sensors associated with home alarm systems like motion sensors 296 and intrusion sensors 298. A home owner 14 may want access to data derived from appliances 300 and other household items like a lawn watering system. A user 14 may be interested in viewing cameras 152H, readings from sensors 152S, and readings from appliances 152T. A user 14 can schedule downloading of his or her content selections 36 as shown in FIG. 45 and as described above.

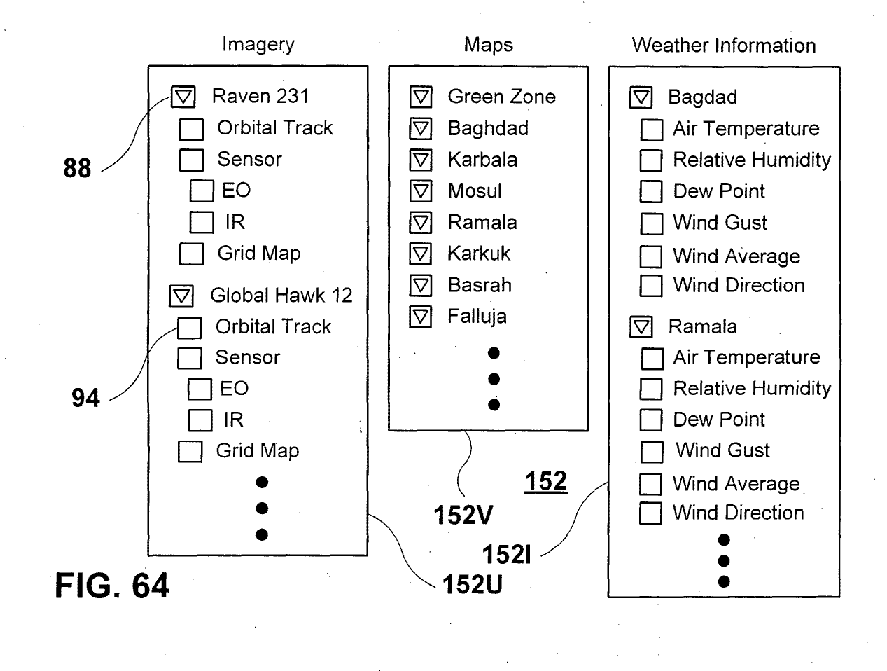

The invention has military applications. A specific embodiment relating to operations planning is shown in FIG. 64. A military operations planner 14 would be interested in data in the form of imagery from Unmanned Aerial Vehicles (UAVs) and satellites 152U, maps 152V as well as weather data 152I. A military operations planner 14 can schedule downloading of his or her content selections 36 as shown in FIG. 45 and as described above.

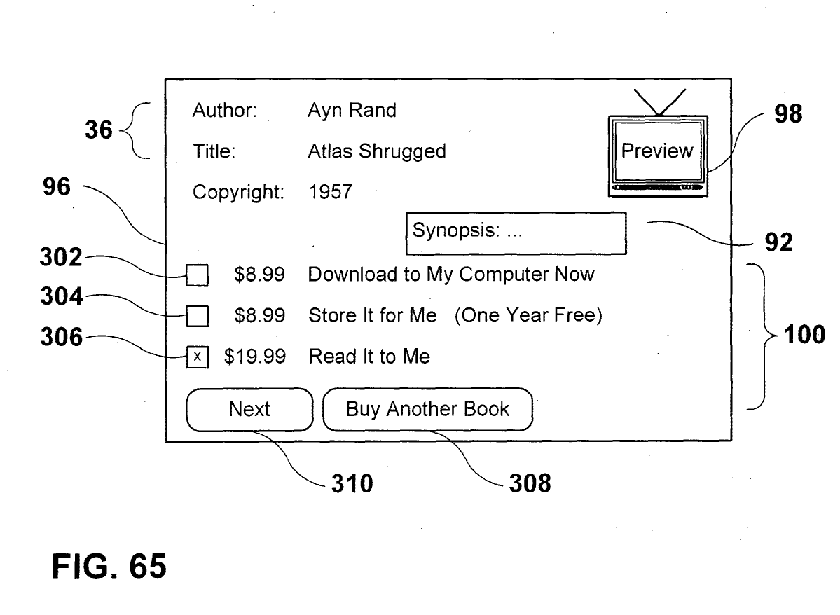

Books on tape are well known. A preferred embodiment of the invention stores the “book” content selection 36 in the network cache 26 and makes it available electronically as shown in FIG. 65. A user 14 can purchase the selected book and have it downloaded to his or her computer by checking box 302. Alternatively, the book can be stored in the network cache 26 by checking box 304. In a preferred embodiment of the invention the user 14 can have the book read to him or her by checking box 306. Pop-up box 310 appears upon clicking the “Next” box 312.

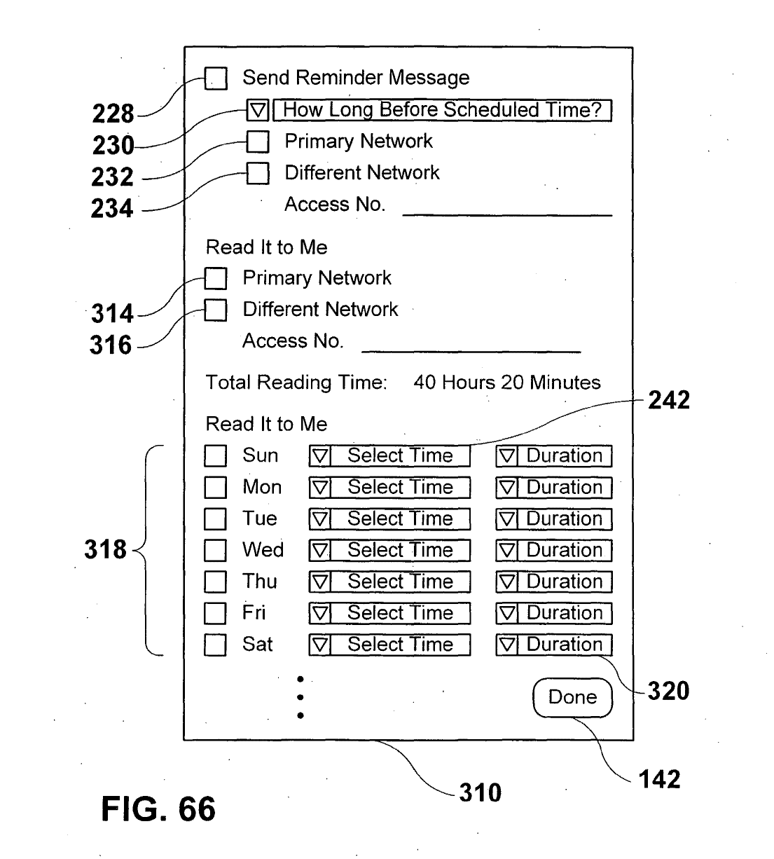

The pop-up box 310 shown in FIG. 66 enables the user 14 to schedule the reading of his or her content selection 36. The user 14 can have the reading transmitted via the primary network 314 registered in FIG. 46, or via an alternative network 316, by clicking the boxes 314,316. The user 14 can select the days of the week 318 and times 242 he or she wants the book to be read to him or her. He or she can also select the duration of the reading session 320.

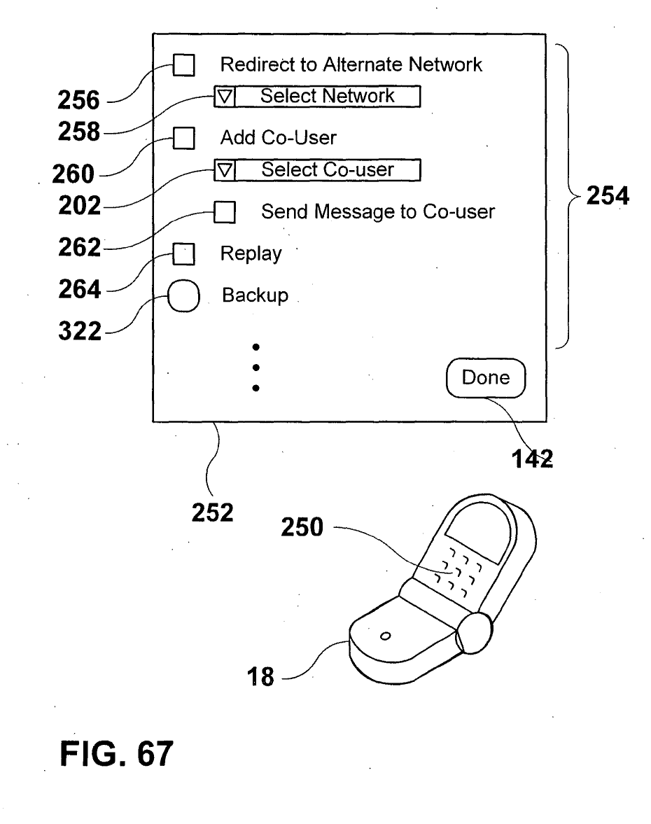

The network cache 26 keeps track of how much of the book content selection 36 has been read. If the user 14 misses a scheduled listening time, he or she can click box 322 on pop-up box 252 to cause the reading to backup to a prior reading session as shown in FIG. 67.

In alternative embodiments, the invention may be used to download other publications beside books, including, but not limited to, publications, newspapers, magazines, and academic journals.

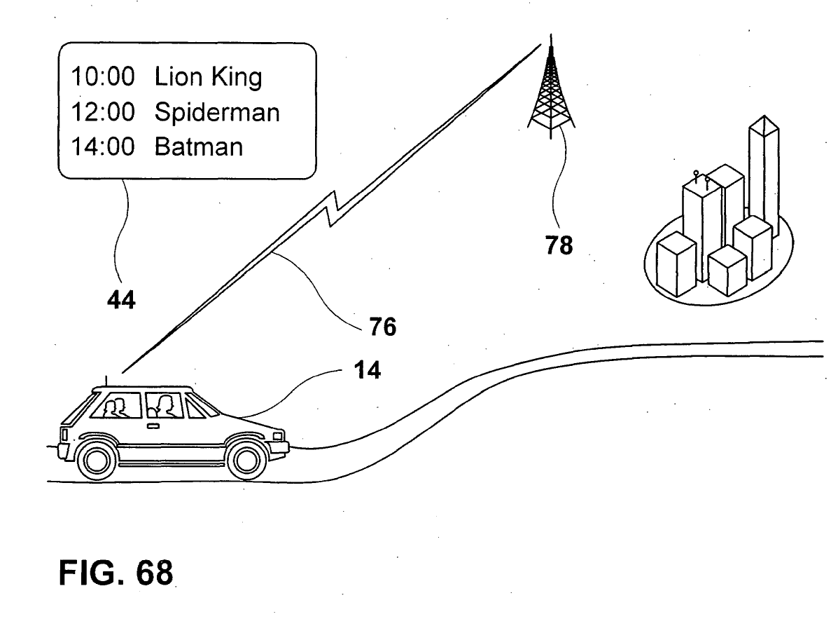

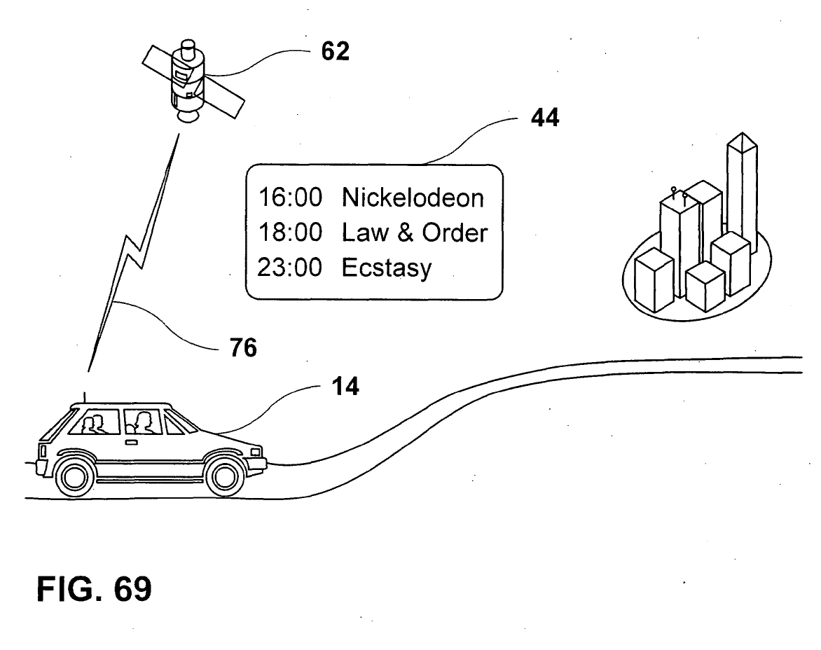

In yet another embodiment of the invention, a family traveling in a car receives content selections 36 that are automatically delivered to their vehicle on the road at a time which they choose. As shown in FIGS. 68 and 69, the content selections 36 may be delivered using a cellular telephone network, a satellite or some other suitable transmission means.

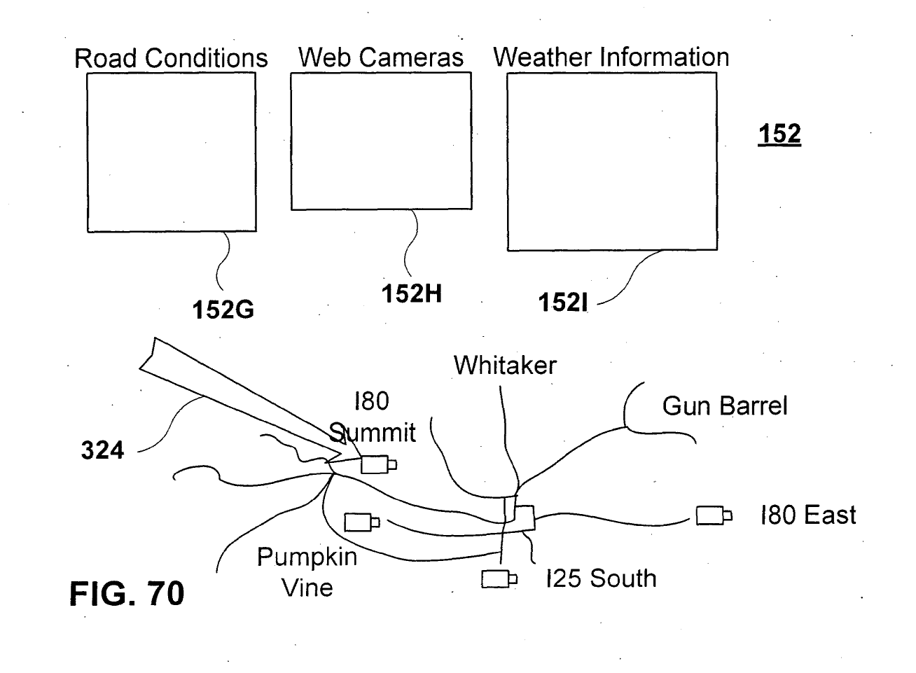

A further alternative embodiment of the disclosed invention is shown in FIG. 70. Here the user 14 enters a geographic area 324 of interest into the Web site 150 and the Web site delivers to the user 14 listings 152 of content selections 36 that are available that refer to or reference the geographic area 324. Entering information on the geographic area 324 may be accomplished by highlighting an area of roadway as shown in FIG. 70 or typing in locations in a text box 326. Other methods of entering such information are in common use on Web sites.

A preferred embodiment of these specific embodiments of the invention registers all of the content selections 36 and scheduling actions and options into a SIM 30.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of Claims.

### LIST OF REFERENCE CHARACTERS

A Subscription satellite system

B Over-the-air broadcast

C Car

D Direct Broadcast Satellite system

E Television

G Cable television system

M Cellular telephone

R Radio

S Distant signal

T Radio transmitter

U User

W Wireless carrier

10 Hometown transmitter

12 Hometown

14 User

16 Distant location

18 Content terminal

18-STB Set top box

20 Network

20-F Foreign network

20-FW Fixed wireless network

20-H Home network

20-I Internet

20-P Private network

20-PTP Peer-to-peer network

22 Content provider

24 Internet Service Provider

≈Network cache

28 Content retriever

30 Subscriber Identity Module (SIM)

32 Content terminal user interface

÷User's content preference

36 User's content selection

38 SIM substrate

40 SIM memory and processor

42 Basic operating information

44 Schedule of content selections

46 SIM slot

48 Wireless transceiver

50 Local location

52 Remote location

54 Network head end

54-F Foreign network head end

54-H Home network head end

56 Satellite Earth station

58 Facilities for collecting, storing and/or distributing content

60 Biometric device

62 Satellite

64-H Home network database

64-F . Foreign network database

66 Network channel structure

68 Centralized database

70 Network identifier

72 Cross reference table

74 Intermediary

76 Wireless signal

78 Wireless base station

80 Devices, conveyances or fixed premises into which content terminals may be embedded

82 Web site home page

84 Search bar

86 Average price for available content

88 Pull down menu displaying available content

90 Specific price for content selection

92 Additional information about the content selection

94 Box to select content selection

96 Pop-up box

98 Preview button

100 Purchase options

102 Individual content selection as originally broadcast

104 Individual content selection with modern day commercials

106 Individual content selection without commercials

108 Unlimited viewing of individual content selection

110 Box to store the individual content selection

112 Box to download the individual content selection

114 “See It Now” button

116 Payment screen

118 “Buy Another Episode” button

120 “Buy a Different Program” button

122 Personal information

124 Payment information

126 “Buy It Now” button

128 Viewing screen

130 Account login

132 Button to create account

134 Additional items for sale

136 Button to begin viewing

138 Storage options screen

140 Storage options

142 “Done” button

144 Account display

146 “Add Content” button

148 “Logout” button

150 Web site

152 Listing of available content

152A Levee media content

152B Buoy media content

152C Graphical information media content

152D Available personnel media content

152E Vehicle media content

152F Supplies and infrastructure media content

152G Road conditions media content

152H Web camera media content

152I Weather information media content

152J Health information media content

152K Airline flight information media content

152L Vessel information media content

152M Vessel alert media content

152N Commodity prices media content

152O Global Positioning System status media content

152P Pump media content

152Q Valve media content

152R Flow meter media content

152S Sensor media content

152T Appliance media content

152U Imagery media content

152V Map media content

154 Fee for listing content

156 Shopping for content

158 User payment

160 Fees to content providers

162 User cache

164 Search request

166 World search

168 World

170 Intermediary fee for acquiring content

172 Market prices

174 Bid box

176 “Make a Bid” button

178 Bid accepted pop-up box

180 “Confirm Purchase” button

182 Bid not accepted pop-up box

184 Counter office price

186 “Accept Counter Offer” button

188 Rebid box

190 “Resubmit Bid” button

192 “Cancel” transaction button

194 Media content distributors

196 User's home location information

198 User's alternative location information

200 Time zone

202 Co-user

204 Pop-up box for registering co-user information

206 First panel of content schedule

208 Second panel of content schedule

210 Box to associate content selection with delivery network

212 Third panel of content schedule

214 Pop-up box displaying content schedule options

216 Schedule options

218 Fourth panel of content schedule

220 “Scheduled” notation

222 “Options” notation

224 Fifth panel of content schedule

226 Options pop-up box

228 Reminder message

230 Drop down menu of time

232 Click box for reminder message via registered network

234 Click box for reminder message via alternate network

236 Click box for adding co-users

238 Drop down menu of registered co-users

240 Click box for delayed broadcast

242 Drop down menu of broadcast times

244 Click box to record broadcast

246 Drop down menu of available recording content terminals

248 Pop-up box to register available recording content terminals

250 Code to bring up pop-up box

252 Pop-up box of options while content selection being broadcast

254 Actions available while content selection being broadcast

256 Click box to redirect broadcast to another network

258 Drop down menu of available alternate networks

260 Drop down menu of co-users

262 Click box to send alerting message to co-user

264 Click box to replay broadcast of content selection

266 A user filled blank

268 A user's travel itinerary

270 List of vessels arriving in a port

272 Box for selecting a vessel

274 Global Positioning System satellite

276 Tractor

278 Well

280 Pipeline

282 Pump

284 Flow meter

286 Valve

288 Camera

290 Electromagnetic emissions sensor

292 Radiological sensor

294 Cargo containers

296 Motion sensor

298 Intrusion sensor

300 Appliance

302 Click box to download book content selection

304 Click box to store book content selection

306 Click box to have book content selection read

308 “Buy Another Book” button

310 “Read It to Me” pop-up box

312 “Next” button

314 Click box to select primary network

316 Click box to select alternate network

318 Days of the week

320 Reading duration selection pull-down menu

322 Backup button

324 Geographic information

1. A method comprising the steps of:
acquiring a plurality of publications in digital form;
displaying a listing of said plurality of publications to a user on a website; and
downloading one of said plurality of publications over a network (20) to a content terminal (18) terminal (18) operated by said user (14); said content selection (36) being downloaded at a future time selected by said user (14); said content terminal (18) being selected by said user (14).

2. A method as recited in claim 1, in which said plurality of publications includes a book.

3. A method as recited in claim 1, in which said plurality of publications includes a magazine.

4. A method as recited in claim 1, in which said plurality of publications includes a newspaper.

5. A method a s recited in claim 1, in which said plurality of publications includes an academic journal

6. A method as recited in claim 1, in which said plurality of publications includes a periodical.
